(19) United States
(12) Patent Application Publication
(10) Pub. No.: US 2002/0038277 A1
(43) Pub. Date: Mar. 28, 2002

(54) Innovative financing method and system therefor

(76) Inventor: Frank S. Yuan, San Marino, CA (US)

Correspondence Address: LYON & LYON LLP, 633 WEST FIFTH STREET, SUITE 4700, LOS ANGELES, CA, 90071, US

(21) Appl. No.: 09/918,334

(22) Filed: Jul. 30, 2001

Related U.S. Application Data
(63) Continuation-in-part of application No. 09/511,650, filed on Feb. 22, 2000.

(51) Int. Cl. G06F 17/60

(52) U.S. Cl. 705/37; 705/26

(57) ABSTRACT

An auction with methods and mechanisms to avoid fraud are described. One fraud avoidance aspect involves the use of a financial institution, such as a factoring entity. The financial institution guarantees at least a partial payment of the amount owed by the winning buyer to the seller in case the winning buyer does not pay. Another fraud avoidance aspect provides the winning buyer with a period of time to inspect the goods or services purchased at the auction before having to pay for them.

An innovative financing method for sales transactions between sellers and buyers to eliminate the use of a letter of credit is described. The financing method involves an agreement between a coordinator, a bank and a factor whereby the buyer's payment obligation is guaranteed by the factor. Based on this guarantee, the bank may advance or loan a portion of the payment price to the seller before the buyer actually pays. This provides certainty in the seller's cash flow needs.

This application is a continuation-in-part of co-pending application Ser. No. 09/511,650, filed Feb. 22, 2000. The contents of that application are expressly incorporated herein by reference.

### FIELD OF THE INVENTION

The invention generally relates to financing methods, and more specifically relates to a method involving banks, factors or other financial institutions to aid in sales transactions of goods and services between sellers and buyers. By involving banks, factors or other financial institutions, letters of credit may be eliminated.

The invention also relates to methods and mechanisms to provide the above-mentioned financing method online. The invention also relates to the interface between the entities participating in the financing method such as a bank, factor, seller and buyer, as well as an entity that coordinates their participation. The invention also relates to achieving the foregoing through a web site on the Internet.

The invention also generally relates to how the innovative financing method may be used with an auction that avoids the risk of fraud to the seller and/or buyer. Fraud on the seller is avoided through the use of a financial or other institution that guarantees payment to sellers who properly deliver the goods or services that were posted during the auction. Fraud on the buyer is avoided by providing the buyer with a certain amount of time to inspect the goods or services before having to pay for them, in order to ensure that they comply with the description posted at the auction.

The invention also relates to methods and mechanisms necessary to provide the above-described auction online. The invention also relates to the interface between the auction provider and the institution used to guarantee payment to the sellers. The invention also relates to achieving the foregoing through a web site on the Internet.

### BACKGROUND OF THE INVENTION

Letters of credit (“LC”) have been used in connection with transactions such as international trade between sellers and buyers for some time. In this situation, a buyer places an order with a seller, but the seller may not ship or even start to produce the ordered items until a letter of credit is in place. Generally, it may take some time for the buyer to obtain a letter of credit. For example, in order to obtain a letter of credit, a retailer seeking to purchase goods or services must typically display some type of collateral, performance measurements, commitment costs or other criteria.

Thus, the process of obtaining a letter of credit may be cumbersome and involves administrative burden. Accordingly, any transaction involving a letter of credit may be delayed or otherwise adversely affected by the time it takes to obtain the LC. Transaction delays may be detrimental to the buyer that needs the ordered items quickly. Delays may also be detrimental to the seller because the cash flow associated with the transaction is not forthcoming to the seller as long as the transaction is delayed.

Furthermore, there are costs associated with obtaining a LC. For example, a bank typically charges a fee for issuing the LC itself. Beyond that, the bank may charge further fees, such as commitment fees, when the LC is presented for negotiations. Other fees may involve a fee for appraising the value of the buyer's collateral that is being used to guarantee the LC, or UCC filing fees. In sum, these various fees may add up to a significant cost of doing business. This cost situation may be exacerbated where the buyer may need to obtain multiple or different letters of credit over time thereby enduring the LC procurement process and expense again and again.

The LC procurement process may also be made difficult where the seller and buyer, as well as their respective banks, are located in different countries. This is because different business cultures, legal systems, languages, time zones, currencies and exchange rates may complicate the process.

Another drawback associated with a LC is the risk assumed by the buyer acquiring the goods based on the LC. That is, the bank issuing the LC is typically not responsible for the quality of the goods shipped to the buyer. As long as the bank issuing the LC receives documents indicating that the goods were shipped by the seller, the bank is typically required to pay the seller's bank. Accordingly, it is not uncommon for sellers to ship poor quality merchandise—or sometimes even empty boxes—and present the issuing bank with shipping documents obligating the bank to pay. In this case, the buyer receives inferior goods and is still obligated to pay the bank. This type of scam occurs in connection with millions of dollars in transactions each year.

Another drawback for the buyer may occur when it is listed in the LC documents as being the importer of record with the Customs Office of the country where the goods are being imported. In the U.S. Customs Office, for example, should there be some type of counterfeit products or improper documents associated with the shipment, this may be noted by U.S. Customs. In this case, by virtue of being the importer of record, the buyer's identity may be maintained in a U.S. Customs database listing entities associated with offending shipments. This may lead to penalties and difficulties in importing future shipments. This is a serious problem especially where the buyer had no involvement in the circumstances that rendered shipment offending. However, if the buyer could avoid using a LC and thereby avoid the need to be listed as the importer of record, any such risk would be avoided.

There is also a downside to sellers where the transaction involves a letter of credit. Where the shipping documents contain minor or even irrelevant errors, e.g., typographical errors that do not match up with the terms or conditions purchase order, it has sometimes happened that the bank issuing the LC refuses to pay the seller's bank. This is so despite the facts that the proper goods had been shipped and the goods were accepted by the buyer. Indeed, it may be that the buyer intentionally creates discrepancies between relevant documents to avoid having to pay. And even besides the downside of such a scam, it may be a real burden on the seller to check and compare all the fine print of the relevant documents to ensure that everything matches up.

Factoring has also been used to facilitate international trade such as where the seller is located in a foreign country and a domestic buyer imports the goods or services. As explained later in this background section, factors generally guarantee the buyer's creditworthiness or payment to the seller for the shipment. To this end, the factor may forward or loan some or all of the payment to the seller and then go about collecting the account receivable from the buyer.

However, current forms of factoring have significant limitations when used in international trade. Indeed, it is believed that current forms of international factoring have not been used in the situation where multiple buyers seek to acquire goods or services from multiple sellers, and where some or many of these sales transactions are one-off. It is believed that current forms of international factoring do not work in this environment due to the logistical, legal and administrative burdens that would arise in this scenario. These burdens may be better understood after describing existing international factoring arrangements.

An international factor may have agreements with a number of buyers. To this end, the factor may have databases of credit information about many buyers thereby allowing it to enter factoring relationships therewith. However, the factor is typically limited to dealing with only one or a limited number of overseas sellers/vendors thereby severely limiting the sources of goods or services. This occurs for several reasons.

First, given the costs involved with investigating an overseas seller's finances and its reputation for selling and shipping proper goods or services, it would not make business sense for a factor to negotiate with multiple overseas sellers, especially for a one-off sales transaction.

Second, a factor typically perfects its legal position with respect to any advance or loan it may make to the seller against the account receivable created by the sales transaction. In the U.S., this is typically done through a UCC filing. Foreign countries have similar mechanisms for a factor to perfect its legal position in the account receivable. However, if multiple overseas sellers were involved, the costs of a factor perfecting its legal position in various foreign countries with respect to various sellers would involve significant administrative, logistical and legal burden. Such burdens would not justify the cost, especially in a one-off sales transaction.

In view of the foregoing, there is a need for a method of financing sales transactions that either eliminates the need for a letter of credit or otherwise streamlines the sales transaction. There is also a need for a method to finance sales transactions that may occur between multiple buyers and sellers, and where some or many of the sales transactions are one-off.

Auctions have been used to sell goods and services for some time, and with the advent of the Internet, auctions now occur online. With online auctions, buyers typically submit bids, and when the winning bid has been determined, the winning buyer typically pays for the goods at that point, e.g., with a credit card, cash or money order. Thereafter, the seller typically ships the goods or provides the services.

A problem associated with auctions, especially those occurring online, is the risk of fraud occurring on either the buyer or seller. With respect to fraud on the buyer, for example, a seller may post a certain item of merchandise in an online auction that ends up being purchased by the highest bidder. However, the merchandise actually received by the buyer may differ from the merchandise posted online, or the merchandise may be damaged or defective. Worse yet, the buyer may never actually receive the merchandise. But because the buyer has typically already paid for the goods or services prior to delivery, the buyer has thus been defrauded because it has paid money for something that is different than that posted during the auction or which is otherwise inadequate. And even if the buyer is able to get the money paid back from the seller, the buyer has still lost use of the money during this time, and has also had to expend time and possibly more money to retrieve the purchase price.

Certain auctions may involve an escrow service which receives the buyer's money when it is determined who submitted the winning bid. But with an escrow service, the buyer has still parted with the money before receiving the goods or services which may be different than those posted at the auction. Accordingly, even though the seller may not instantaneously receive payment because the money is with an escrow service, the buyer has still parted with the purchase price and still runs the risk of being defrauded. At a minimum, the buyer runs the risk of losing use of the money until any bad situation is rectified and the money returned from escrow.

With respect to fraud on the seller, if the auction does not involve the immediate payment by the buyer, the buyer may end up receiving the proper merchandise posted during the auction but then fail to pay for it. In this case, the seller has been defrauded because it has shipped the proper item but receives no payment. And in this situation, the seller typically waits for payment for some period of time before it becomes apparent that payment is not forthcoming. Had the seller known that payment was not forthcoming, it might have approached the second-place bidder as an alternate buyer. But because the seller is still expecting payment from the winning bidder, by the time the fraud becomes apparent the second-place bidder will most likely have moved on with alternate arrangements. So besides the problem of having shipped the merchandise to the fraudulent buyer, the seller also loses out on a proper sale.

Problems associated with fraud may be exacerbated in online auctions because such auctions are not face-to-face. Instead, the parties involved are remote from each other so there is no real opportunity for the buyer to inspect the items being auctioned, or for the buyer and seller to meet face-to-face in order to create some type of business relationship prior to money changing hands. To this end, because the sellers and buyers interfacing through online auctions do not know each other, they may not know each others' reputations and may thus be selling or buying items where a high chance of fraud exists.

The risk of fraud may also be increased in the wholesale environment as opposed to retail transactions. In typical retail transactions, the buyer may simply pay cash for the items purchased. In this situation, the seller receives the money at the time of the transaction so there is little or no chance that the seller will be defrauded. Alternatively, the buyer may use a credit card or other bank card for the purchase. But here again, the seller is protected against fraud because the bank that issued the card will stand behind the buyer and thus guarantee payment. Conversely, for retail transactions that occur face-to-face, the buyer can inspect the items being purchased to ensure that they are of proper quality before money changes hands. And if they are not, the seller can be confronted then and there.

But in the wholesale environment, which may involve transactions between a supplier and a manufacturer, or between a manufacturer and a retailer, the seller typically receives no such protection. This is because most wholesale transactions do not involve cash or credit cards, but instead involve terms which provide for payment within some amount of time. Accordingly, the seller does not receive money at the time of the transaction and does not benefit from any bank standing behind the user of a credit card. Conversely, many wholesale transactions do not occur face-to-face so the buyer may not have the opportunity to inspect the items before money changes hands. It should be noted that these problems may also apply to retail transactions, but in any event, may be exacerbated in the wholesale environment.

Besides the fraud which may arise in connection with an auction, another problem associated with an auction transaction gone awry is wasted time. That is, after the auction occurs and the highest bidder wins, the seller and buyer have a reasonable expectation that the transaction is consummated and the only remaining tasks are for the items to be shipped and, if it has not already occurred, money to change hands. However, where the items are provided at some time later and turn out to be defective or otherwise inadequate, time has been lost. This may create significant problems for buyers who needed the goods or services in order to consummate business with third parties. Conversely, where the proper items are provided but payment is not forthcoming, time has again been lost, in this case for the seller. Unfortunately, significant time may pass before the seller and/or buyer realize(s) this. And for either a buyer or seller, such lost time may jeopardize their business plans when it comes to light that the proper items or monies have not been received.

Financial institutions have been used in connection with the sale of goods and services for some time. For example, if the seller meets certain qualifications, the seller may enter into an agreement with a financial institution whereby the financial institution will guarantee the buyer's credit worthiness or payment to the seller for goods sold. To this end, the financial institution may advance some or all of the payment to the seller and then go about collecting the account receivable from the buyer. As such, the financial institution may assume the risk of nonpayment by the buyer. In return, the financial institution typically receives a commission or some other fee from the seller.

An example of this type of arrangement involves financial institutions known as factors whereby the factor and seller enter into what is known as a factoring agreement. This agreement typically specifies the type of payment guarantee that will be provided to the seller, the type of risk that will be assumed by the factor, the commission or other fee to be received by the factor and other pertinent terms.

However, financial institutions such as factoring entities have not been involved in an auction setting. A reason for this may derive from the one-on-one relationship between the financial institution and seller that is typically associated with factoring or other types of payment guarantees provided by financial institutions. That is, financial institutions typically require some amount of time to process an application by the seller, run financial checks on the seller and become generally familiar with the seller before it will make any type of payment guarantee.

However, the time required for this process runs contrary to an auction process where a seller may want to quickly post goods or services for sale without having to go through any type of time-consuming financial evaluation. Indeed, the auction setting provides little or no time for the classical approach to factoring or other types of payment guarantees whereby one-on-one relationships are established before any risk is assumed by the financial institution. Accordingly, it can be seen why financial institutions would not want to rush into providing payment guarantees for sellers at an auction, because if it did, the financial institution could very well be assuming unknown and unnecessary risks that it would not have assumed had the classical one-on-one approach been followed.

Consequently, auctions that currently exist have not benefited from the security and fraud-avoidance benefits that may be provided by a financial institution such as a factor. Furthermore, many auctions do not provide any type of time period for buyers to inspect or otherwise ensure that the items purchased conform to what was posted during the auction or that the items are free from defects.

In view of the foregoing, there is a need for an auction system and method that avoids the risk of fraud and the waste of time described above. To this end, there is a need for an auction involving a financial institution which guarantees payment on certain conditions so that sellers can offer their goods to buyers with the benefit of the protection provided by guaranteed payment. There is also a need for an auction whereby the buyer has an amount of time to inspect the goods or services before parting with his or her money. And in today's rapidly expanding world of e-commerce, there is a need for the foregoing to occur online.

### SUMMARY OF THE INVENTION

The current invention addresses the need for a streamlined method of financing by eliminating the need for a letter of credit between buyers and sellers, and by efficiently allowing the use of factoring. An aspect of the financing method of the current invention involves a tri-party agreement and assignment between the coordinator of a sales marketplace, a financial institution such as a factor that guarantees the buyer's credit and that is obligated to collect the buyer's payment, and another financial institution such as a bank that is associated with the seller.

Based on the factor's guarantee of the buyer's credit and an obligation to pay the bank upon collection of the buyer's payment, the bank may provide an advance to the seller against the sales price thereby providing the seller with cash flow. Upon the buyer's payment to the factor, the factor pays the bank that may in turn pay the seller the remaining amount of the sale. Based on the tri-party (assignment) agreement, the factor also pays an agreed-upon payment to the coordinator, and the coordinator may negotiate a mark-up or fee with the buyer for arranging the transaction.

In another aspect of the financing method of the current invention, the coordinator provides the sales marketplace whereby buyers and sellers may transact business, including one-off sales transactions, without the need for letters of credit.

The current invention also addresses the need to avoid fraud in an auction context by providing an auction that involves a financial institution, such as a factoring entity, to provide some form of guaranteed payment to sellers who deliver appropriate goods or services. The current invention also addresses the need to avoid fraud by providing the buyer with an amount of time to inspect the goods or services before actually having to pay for them. The current invention also serves to avoid fraud by combining these concepts, and by providing for the foregoing to occur online.

The current invention may be embodied by a web site on the Internet that includes access to the innovative financing method, other services offered by the coordinator and/or an auction center. Sellers who have met the criteria of the entity managing the auction and the financial institution may sell items in the auction center and receive guaranteed payment where appropriate. It is preferred that sellers are able to apply online to receive the benefit of a factoring or other similar agreement. Buyers who meet criteria to participate in the auction center are provided with a time period, e.g., 30 days, in which to evaluate the goods or services that they receive before actually having to pay for them. The buyers' credit may also be pre-qualified online so that the risk of nonpayment is decreased. Thus by involving a financial institution and by providing a pre-payment evaluation period, the risk of fraud to the seller and buyer is avoided.

### DESCRIPTION OF THE FIGURES

FIG. 1 is a flowchart showing an overall schematic of the entities involved with an auction center of the current invention and their relationships.

FIG. 2 is a flowchart describing an auction from the viewpoint of a financial institution that will provide some form of payment guarantee to sellers, and who may pre-qualify buyers before they bid at the auction.

FIG. 3 is a flowchart describing an auction from a seller's viewpoint.

FIG. 4 is a flowchart describing an auction from a buyer's viewpoint.

FIG. 5 is a flowchart showing an overall schematic of the entities involved with a sales marketplace and their relationships.

FIG. 6 is a flowchart showing steps pertaining to a buyer's credit approval and placing a purchase order in the financing method.

FIG. 7 is a flowchart showing steps pertaining to a supplier receiving a purchase order, a shipment being made and payment of the sales price.

FIG. 8 is a flow chart showing steps pertaining to a buyer receiving a shipment and payment of the invoice in the financing method.

### DETAILED DESCRIPTION OF THE PREFERRED EMBODIMENTS

In a preferred embodiment, the auction of the current invention may be embodied as a web site on the Internet. Various types of business transactions may occur via the auction. For example, the auction may be used as a business-to-business vertical marketplace or community where manufacturers, wholesalers and jobbers can liquidate bulk product quantities including odd lots and close-outs. Retailers of varying sizes may also participate in the auction to efficiently source product at better prices. The subject matter of the goods and/or services to be auctioned may also vary. In one example, the products to be auctioned may involve clothing and clothing accessories. However, a multitude of other products and/or services may be auctioned using the method of the current invention.

In the current invention, a particular web site may host multiple auctions on different web pages according to the subject matter of the goods and/or services being auctioned. Alternatively, different web sites may exist, each having its own auction according to a particular subject matter of goods or services being auctioned. As yet another alternative, one auction site may be used for goods and/or services that are unrelated to each other.

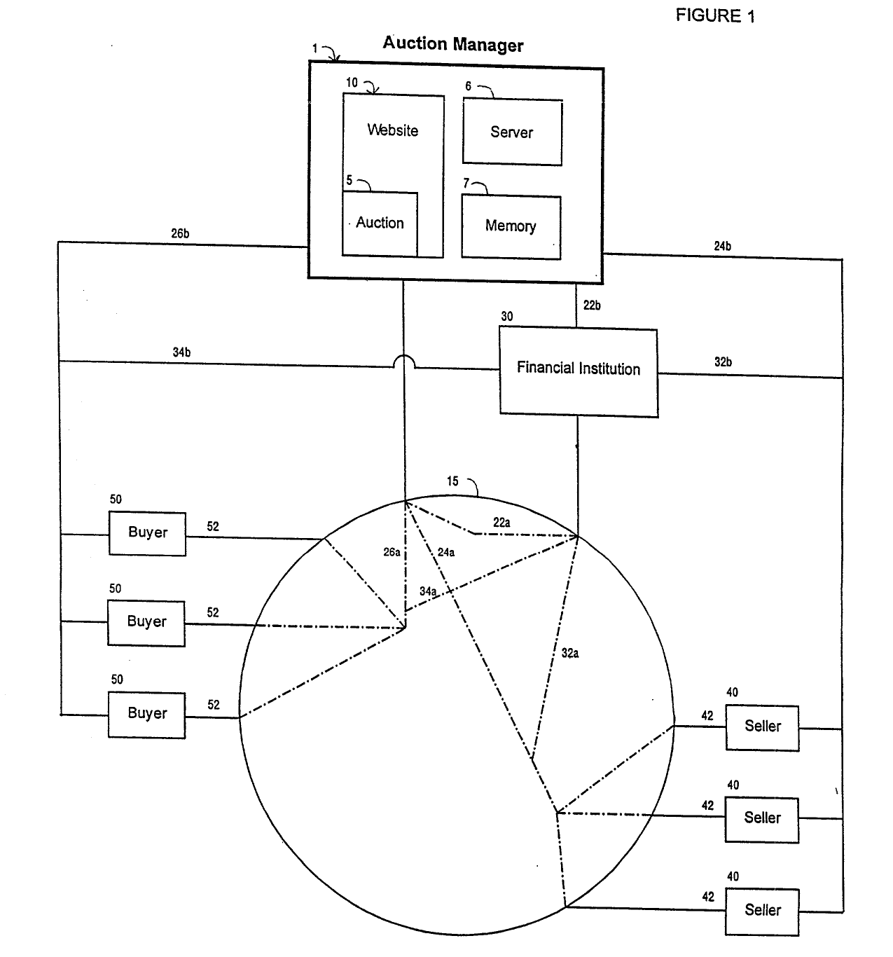

Referring to FIG. 1, the entities involved in the auction and the relationships between these entities are now described. As shown, auction manager 1 may provide an auction 5. For purposes of the following discussion, auction manager 1 generally refers to the entity that coordinates the auction. To this end, and in a preferred embodiment, auction 5 may be contained on a web site 10 that may be administered by auction manager 1. In order to provide the auction, auction manager 1 may also include a server 6 on which web site 10 may reside, as well as any memory 7 that may be accessed for the auction or other purposes.

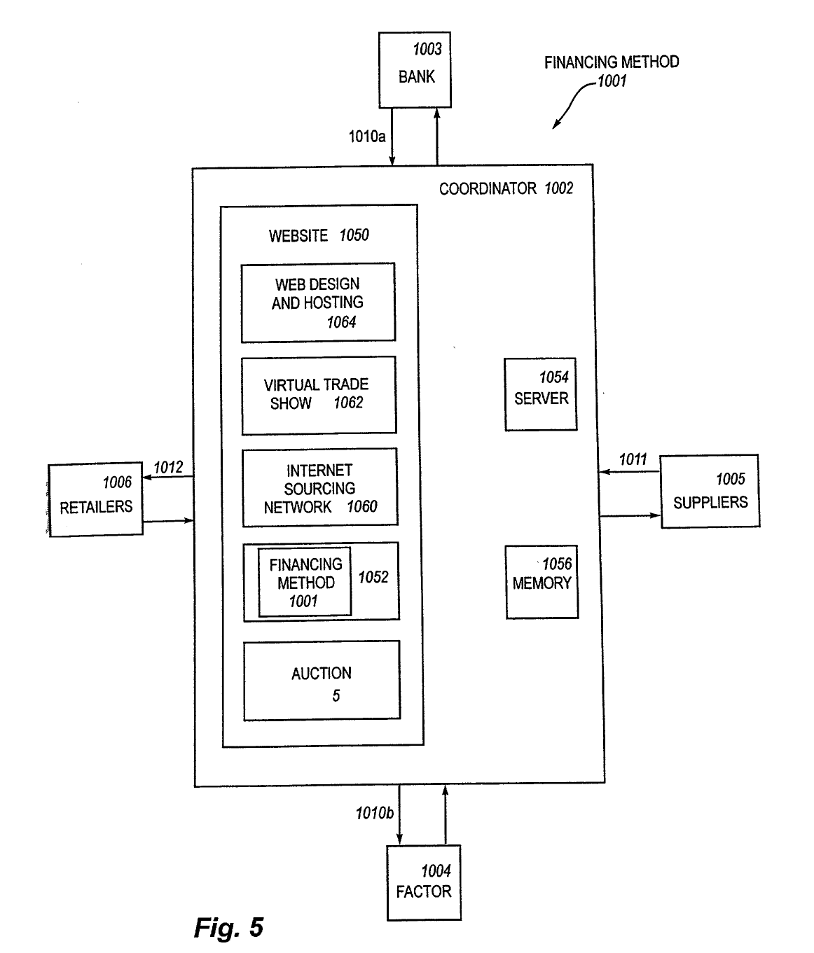

In FIG. 1, auction 5 is shown as a part of web site 10 because auction manager's web site 10 may provide other functions beside auction 5 such as those discussed later in connection with FIGS. 5-8. To this end, there may be several auctions 5 on web site 10, or alternatively, auction manager 1 may provide multiple auctions on separate web sites. Accordingly, FIG. 1 is not intended to limit the current invention to one auction occurring on one web site.

The other entities involved with auction 5 may be factor 30, sellers 40 and buyers 50. It is preferred that these entities be electronically linked through the Internet 15 or some other type of network. Such electronic communication preferably reduces the transactional costs associated with holding the auction and also preferably increases efficiency. As shown in FIG. 1, auction manager may be linked to financial institution 30 by electronic link 22a, to sellers 40 by electronic link 24a and to buyers 50 by electronic link 26a. Furthermore, financial institution 30 may be linked to sellers 40 via electronic link 32a and to buyers 50 via electronic link 34a.

The electronic links that extend from financial institution 30 to sellers 40 and to buyers 50 may allow online applications to be filled out and evaluated. For example, sellers 40 may apply online for the services of the financial institution 30, e.g., payment guarantees as discussed in more detail later. As another example, buyers 50 may fill out and transmit online credit applications to financial institution 30.

In any event, the current invention is not limited to auctions occurring solely by electronic means, as the fraud avoidance aspects disclosed herein may be used in more traditional, physical auctions. Furthermore, even where online connectivity between the parties is used, the current invention may include the use of non-Internet, more traditional modes of communication between the entities such as phone conversations and other human or documentary communication. To this end, auction manager 1 may be linked to financial institution 30 through non-Internet communication line 22b, to sellers 40 through line 24b and to buyers 50 through line 26b. In this manner, the entities may communicate through whatever means necessary to assure the integrity and efficiency of auction 5.

For purposes of this discussion, the relationships or agreements between the parties are explained by using the foregoing reference numerals without the “a” or “b”. As an example, the relationship or an agreement between auction manager 1 and financial institution 30 is discussed by general use of the reference numeral 22. As another example, the agreement between financial institution 30 and seller 40 uses reference numeral 32. This may include contractual obligations between the pertinent parties.

Where financial institution 30 is a factoring entity, relationship 22 between auction manager 1 and factor 30 may obligate factor 30 to pay certain commissions and/or fees to auction manager 1 for each factoring agreement that factor 30 obtains by virtue of its association with auction 1. Similar arrangements can also exist between auction manager 1 and other types of financial institutions 30 such as banks or credit assurance companies. That is, bank 30 or credit assurance company 30 may pay a fee or commission to auction manager 1 for each agreement that is obtained with a seller 40 by virtue of the bank's or credit assurance company's association with auction 5.

Relationship 22 between auction manager 1 and financial institution 30 represents a novel aspect of the current invention pertaining to the use of a financial institution in an auction setting. Relationship 22 reflects a significant difference from the classical one-on-one approach that exists between a financial institution and a seller for which it will guarantee payment. That is, with relationship 22, financial institution 30 need not establish one-on-one relationships with each seller 40, which may in any event not be possible if sellers 40 want to quickly participate in auction 5 instead of going through a time-consuming evaluation process. Instead, financial institution 30 has a one-on-one relationship 22 with auction manager 1, and it may be auction manager 1 that attracts and develops relationships 24 with sellers 40. This is discussed in more detail below in connection with single transaction factoring agreements.

Referring now to the other relationships or agreements between the other parties in FIG. 1, agreement 32 may represent the agreement in place, e.g., factoring agreement, between financial institution 30 and sellers 40. As another example, relationship 24 between auction manager 1 and seller 40 may generally provide that a seller 40 agrees to be bound by certain auction rules in order for seller 40 to participate in auction 5. As another example, relationship 26 between auction manager 1 and buyer 50 may also set forth auction rules that buyer 50 must follow in order to participate in auction 1.

As shown in FIG. 1, sellers 40 may have a relationship 42 with auction 5. This generally represents the seller's posting of goods and/or services to be auctioned and the actual sale of such goods and/or services. Buyers 50 may also have relationship 52 with auction 5 which represents the buyer's bidding on and purchasing of goods and/or services via auction 5.

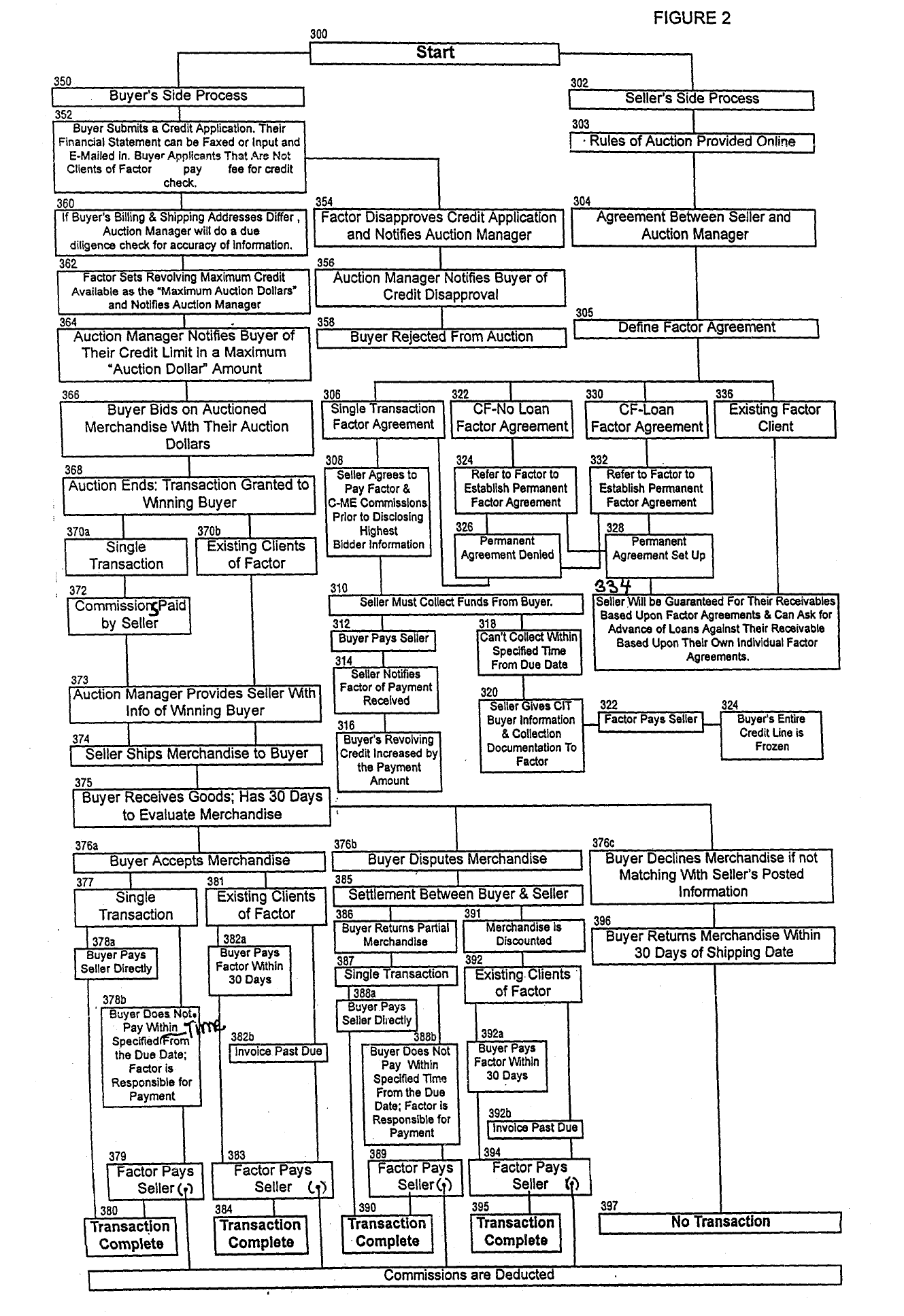

Now that the entities involved with auction 5 have been described, the manner in which these entities interact with each other and with auction 5 is more fully described with reference to FIGS. 2, 3 and 4. FIGS. 2, 3 and 4 show the auction method of the current invention from the viewpoints of the factor or other financial institution 30, seller 40 and buyer 50, respectively.

Referring now to FIG. 2, the method from the financial institution's viewpoint begins at step 300. For purposes of the following discussion, the financial institution is generally referred to as being a factoring entity. However, the current invention includes the use of other types of financial institutions that may provide services for use in avoiding fraud in the auction context. Examples include, but are not limited to, banks and credit assurance companies. Accordingly, throughout this application, including the discussion both above and below, the use of the phrase “factor”, “factoring” or “factoring agreement” is not intended to limit the scope of the invention to this type of particular financial institution.

Upon the method starting with step 300, it is preferred that factor 30 has a relationship 22 (FIG. 1) with auction manager 1 regarding factoring agreements to be entered into for purposes of auction 5. As mentioned above, relationship 22 may involve some sort of contractual obligation whereby factor 30 pays a certain commission or fee to auction manager 1 for each such factoring agreement. That factor 30 would pay such fees or commissions is reasonable because the factor's participation in auction 5 will expose it to numerous prospective sellers, which in turn will lead to numerous factoring agreements which may each involve fees or commissions being paid by sellers 40 to factor 30.

As shown in FIG. 2, factor 30 may be involved with a seller's side process 302 and a buyer's side process 350. The seller's side process 302 is discussed first. Generally, it is preferred that sellers 40 may be able to learn about auction 5 and apply to participate therein online over the Internet 15. To this end, it is preferred that web site 10 provide the ground rules of auction 5 online, as shown in step 303, so that seller 40 may determine whether it wants to participate in the first place.

One possible ground rule of auction 5 may be a minimum posting requirement, i.e., a minimum value of the goods or services to be posted for auction, for seller 40 to be able to participate in auction 5. Due to transactional costs incurred by auction manager 1 and the risks assumed by factor 30 when providing some form of payment guarantee, it may not make economic sense to provide auction access to sellers that want to post goods or services having too small a value. Accordingly, auction 5 may have a minimum posting requirement, e.g., $5,000.

Another possible ground rule is that seller 40 will pay a certain fee or commission to auction manager 1 for each sale consummated via auction 5. Such a fee or commission would be reasonable since participation in auction 5 would expose seller 40 to numerous prospective buyers 50.

Assuming seller 40 wishes to proceed and participate in auction 5, seller's side process 302 may continue with steps 304, 305 whereby seller 40 fills out online applications to be evaluated by auction manager 1 and factor 30, respectively. For example, rules 303 may be set forth on a web page for seller 40 to view, and at the end thereof, seller 40 may be requested to provide pertinent contact and financial information. After doing so, seller 40 may then be prompted to click an “accept” icon or “reject” icon appearing at the end of the application. The seller's acceptance may serve to submit its application (step 304) to participate in auction 5. Upon its receipt of the seller's application, auction manager 1 may be provided with several days or some other amount of time in order to accept or reject the prospective seller's application. If accepted by auction manager 1, agreement 24 between auction manager 1 and seller 40 may be established.

In similar fashion, seller 40 may also submit an online application as in step 305 to factor 30 that will result in agreement 32, e.g., a factoring agreement. Different types of possible factoring agreements 32 may appear on the prospective seller's computer screen. And if the prospective seller finds a factoring agreement acceptable, it may then submit an application to factor 30. This may occur by the prospective seller providing information about itself in an online form and clicking an icon that indicates that the prospective seller agrees to bound by the terms of the factoring agreement in order to participate in auction 5. Upon its receipt of the application, and depending on the type of factoring agreement at issue, factor 30 may be provided with some amount of time to consider the application.

It should be noted that the prospective seller's applications with auction manager 1 and factor 30 need not necessarily be submitted online through the Internet 15. Instead, hardcopy documents may be used. Furthermore, it may not be necessary that the seller submit its application to auction manager 1 prior to submitting its application with factor 30. Either of steps 304, 305 may occur first.

Furthermore, it may also be that seller 40 does not need or desire factoring services. In this situation, he may not apply with factor 30, but instead may simply apply to participate in the auction 5 without the benefit of some form of payment guarantee. However, it is still preferred that a buyer 50 of that seller's goods or services still be provided with a period of time in which to inspect the delivered goods or services so that fraud on the buyer is avoided.

As shown after step 305 in FIG. 2, various types of factoring agreements may be entered into between factor 30 and seller 40. The terms and conditions of the factoring agreement 32 may vary depending on whether factor 30 and seller 40 have a prior relationship, the amount of risk to be assumed by factor 30 and the extent of services to be provided by factor 30. Several types of factoring agreements 32, and how they function in related to auction 5, are now discussed in more detail.

As shown in step 306, a first type of agreement 32 between factor 30 and seller 40 may cover a single transaction, e.g., one sale by seller 40 at auction 5. This agreement may also require that seller 40 attempt to collect payment for some agreed upon time period before factor 30 becomes liable for the account receivable.

Under this arrangement, and as shown in step 308, seller 40 may be obligated to pay the appropriate commissions and/or fees to auction manager 1 and factor 30 up front, i.e., before information on the winning bidder is disclosed to seller 40. It is preferred that fees or commissions be paid prior to disclosure of information on the winning bid to prevent seller 40 from circumventing the auction process after having received the benefit of obtaining a buyer through the auction.

When considering this single transaction agreement 32, factor 30 may evaluate the size of the account receivable, the seller's 40 ability to collect payment from the buyer 50 as well as the credit worthiness of the winning bidder 50. But with respect to the buyer's credit, it is preferred that the buyer 50 would have had its credit approved prior to participating in auction 5. Accordingly, the risk of providing some form of payment guarantee is not so large as it might be if buyer's credit had not been prechecked. In any event, these factors may in turn determine the size of the payment guarantee that factor 30 is willing to extend to seller 40.

After the information regarding the winning bidder is disclosed to seller 40, seller 40 may then ship the goods or provide the services to buyer 50. The factoring agreement 32 may have a term which provides that the payment guarantee is contingent upon the proper goods or services being delivered, i.e., those posted at the auction. Along with the goods or services, an invoice or other appropriate documentation may be sent to buyer 50 electronically and/or in hard copy document form. That an invoice is generated to buyer 50 may also help avoid fraud because should the incorrect buyer receive an invoice for items it did not bid on, the incorrect buyer can notify auction manager 1 of the error prior to delivery. A proof of delivery may also be sent to auction manager 1 and factor 30 to establish that the proper goods or services were delivered Per the factoring agreement 32 of step 306, seller 40 may then be provided some amount of time to collect payment from buyer 50 as shown in step 310. If seller 40 is successful in collecting payment as shown in step 312, seller 40 may notify factor 30 that the payment has been received as in step 314. As shown in step 316, the seller's successful collection may serve to develop a good track record and may result in an increase in the payment guarantee that factor 30 is willing to provide in future transactions. Factor 30 may also agree to increase the credit limit of buyer 50 based on their payment.

The alternative scenario is where seller 40 is unsuccessful in collecting payment the some period of time provided for in agreement 32 as shown in step 318. Here, seller 40 may provide factor 30 with information pertinent to the collection attempts and may request payment from factor 30 as shown in step 320. At this point, factor 30 follows through on the guaranteed payment as in step 322 thereby serving to avoid fraud on the seller 40 who delivered the goods or services as originally posted at the auction but was not paid therefor.

Factor 30 then also assumes the obligation to collect payment. Based on the buyer's 50 poor track record generated from this scenario, however, the buyer's credit line for the auction may be frozen as shown in step 324. In this manner, buyer 50 may not be able to participate in further auctions 5 until payment is made to factor 30. Buyer 50 may also be precluded from further auctions 5 until additional credit rehabilitation requirements are met. This aspect again shows how the current invention serves to avoid fraud. That is, the buyer who has failed to pay, is prevented from perpetrating further fraud in subsequent auctions 5 until its credit is re-established.

This factoring arrangement 306 which covers one transaction may generally involve less risk to factor 30 than other types of standard factoring agreements because factor 30 receives an up-front fee and does not assume any risk until after seller 40 first attempts to collect payment. However, this arrangement may still be desired by seller 40 because it may involve a smaller fee due to the smaller risk assumed by factor 30. Such an arrangement may also be desirable where factor 30 and seller 40 have no prior relationship, and where the seller's other existing accounts receivables are already processed with another factor or other financial institution.

Though factor 30 may initially receive an application from seller 40 and may perform some amount of evaluation, it is intended that the single transaction agreement be provided quickly. To this end, it is preferred that the majority or vast majority of prospective sellers 40 that seek to participate in auction 5 with auction manager 1 will be able to readily obtain a single transaction agreement. This serves to allow seller 40 to participate in auction 5 as quickly as possible.

As such, the single transaction factoring agreement represents a deviation from the classical one-on-one approach that exists with typical factoring or other payment guarantees made by financial institutions. That is, prospective sellers generally interface with auction manager 1 and have a relationship 24 therewith in order to participate in auction 5. And by virtue of this relationship 24, prospective sellers may readily obtain a single transaction factoring agreement without undergoing an extensive evaluation process and establishing an in-depth one-on-one relationship with factor 30. Indeed, at least on the front end, the relationship with factor 30 is more or less with auction manager 1 rather than with a multitude of sellers 40. To this end, the relationship between factor 30 and seller 40 does not really come significantly into play unless buyer 50 reneges on the purchase price. Also, it is contemplated that auction manager 1 may itself provide single transaction agreements.

As mentioned above, the single transaction factoring agreement 306 may be especially suited for sellers having no prior track record with factor 30. However, it is preferred that seller 40 develop a good track record with factor 30 after consummating several sales via auction 5 wherein the single transaction agreement was used. For example, seller 40 may develop a good track record where it consistently delivered the appropriate goods or services as they were posted during the auction and where it successfully collected payments from buyers 50 thereby avoiding the need for factor 30 to expend much effort.

Where a good track is established, seller 40 may have the option to obtain a factoring agreement that provides more service by factor 30. An example is a factoring agreement that covers multiple transactions and wherein factor 30 advances all or part of the account receivable without seller 40 having to first attempt to collect it. This type of agreement is referenced in FIG. 2 as step 322. Another example is a factoring agreement that has these attributes but that also allows seller 40 to borrow money against its accounts receivables. This type of agreement is shown in FIG. 2 as step 330.

For a seller to obtain one of these fuller-service factoring agreements, factor 30 may by that time have had ample time to assess the seller's performance and thereby establish more of the one-on-one relationship that is typically associated with classical factoring. However, it is contemplated that the readily-available single transaction factoring agreement, along with its deviation from the classical one-on-one relationship between seller and factor, will place sellers in a position to obtain a fuller-service agreement.

From a business standpoint, the current invention provides that sellers 40 may start out with single-transaction factoring agreements 306 which provides sellers that may not otherwise be eligible for factoring agreements the ability to transact business in auction 5. As mentioned above, it is intended that prospective sellers will be able to readily obtain a single transaction agreement. But based on a good track record, sellers 40 may then essentially graduate to more service-laden factoring agreements 322, 330 which will provide more service and flexibility in the way sellers 40 may do business. Accordingly, the utility of the method of the current invention is shown. Another aspect of the utility of this business method is that each of these different types of factoring agreements generate fees and/or commissions for auction manager 1 and factor 30 which in turn allow auction 5 to be held in the first place.

The factoring agreement of step 322, which is generally referred to as a no-loan factoring agreement is now more fully discussed. As mentioned above, this type of factoring agreement is different than the single transaction agreement discussed in step 306 for several reasons. First, this type of factoring agreement may cover a series of sales transactions that seller 40 may consummate via auction 5 instead of just one. Accordingly, in this alternative, a new factoring agreement for each sale on auction 5 is unnecessary. Second, this type of factoring agreement may not require that seller 40 first attempt to collect payment from buyer 50 before requesting payment form factor 30. Instead, after the winning bidder is designated and seller 40 has delivered the goods or services, seller 40 may request payment from factor 30 at that time.

In any event, as shown in step 324, seller 40 may be referred to factor 30 to determine whether seller 40 qualifies for the no-loan factoring agreement 322. If seller 40 does not qualify, as shown in step 326, it may be referred back to the single transaction factoring agreement 306. In this scenario, seller 40 may consummate another transaction via auction 5 in hopes of establishing or fostering its track record such that at some point, it may obtain a no-loan factoring agreement 322 for subsequent transactions.

If seller 40 does qualify for the no-loan factoring agreement, the appropriate no-loan factoring agreement 322 may be entered into, and seller 40 may then transact business via auction 5 with the enhanced benefits of this type of factoring agreement 322. That is, seller 40 may sell goods or services and receive partial or full payment from factor 30 without first having to attempt collection itself. This may increase the seller's cash flow and provide other commercial benefits.

Similar to the other relationships and agreements between the parties discussed above, it is preferred that the seller/factor relationship 32 involving either of the factoring agreements 306, 322 may be consummated online via communication 32a (FIG. 1). However, non-Internet communication 32b may also be used.

The type of factoring agreement that provides the foregoing benefits but that also allows seller 40 to borrow against its accounts receivable is now discussed with reference to step 330. This type of factoring agreement is generally referred to as a loan factoring agreement. Here, seller 40 may again be referred to factor 30 to determine whether seller 40 qualifies for this type of factoring agreement as shown in step 332. If not, seller 40 might be given the option of a no-loan factoring agreement 322. Alternatively, seller 40 may be referred to the single transaction factoring agreement as shown in steps 326, 306.

If seller 40 does qualify for the loan factoring agreement, the appropriate loan factoring agreement 330 may be entered established as shown in step 328, and seller 40 may then transact business via auction 5 with the enhanced benefits of this type of factoring agreement 330. That is, seller 40 may sell goods or services and receive partial or full payment from factor 30 without first having to attempt collection itself, and may also borrow against its accounts receivable as shown in step 334. With this type of factoring agreement, interest fees from seller 40 to factor 30 on such loans may be generated. In any event, the enhanced benefits provided by this type of factoring agreement may increase the seller's cash flow and provide other commercial benefits.

In addition to the scenarios involving the single transaction factoring agreement 306, the no-loan factoring agreement 322 and the loan factoring agreement 330, another scenario accommodated by the current invention is where seller 40 is an existing client of factor 30 as shown in step 336. Here, seller 40 presumably has some type of good track record with factor 30 and may thus participate in auction 5 with the benefit of a no-loan or loan factoring agreement as shown in step 334. However, it is intended that this type of seller 40 still register for auction 5 via the application process with auction manager 1. As with the establishment of other relationships discussed above, it is preferred that sellers 40 that are existing clients of factor 30 register for auction 5 online. However, non-Internet communications may still be used.

For all the types of factoring agreements discussed above, it is preferred that factor 30 quickly perform whatever research is necessary before it enters into an agreement with a prospective seller. Where the prospective seller is an existing client, no research may actually be necessary. Where the single transaction agreement 306 is to be used, the research necessary may be minimal since less up-front risk is being assumed by factor 30. Where fuller service factoring agreements, e.g., no-loan or loan agreements 322, 330, are being considered, factor 30 may need additional time to perform UCC checks and the like. In any event, it is contemplated that online research may reduce the amount of time necessary.

Reference is now made to the buyer's side process 350 of FIG. 2. The first step in this process may be an application step 352 where buyer 50 may submit a credit application in order to participate in auction 5. As discussed later, this application may also pertain to credit approval for other services provided by auction manager 1. The application may include whatever financial information is necessary. The application is preferably submitted online 26a (FIG. 1) through auction manager 1 which may the pass the application on to factor 30. For example, the credit application may simply appear as a form with fields on the prospective buyer's computer screen that may be readily filled out. However, non-Internet communication 26b (FIG. 1) may also be used in the application process, e.g., faxed financial statements, telephone calls to verify information, etc. Alternatively, the credit application may be directly transmitted to factor 30, but here, it is still preferred that auction manager 1 be kept apprised of prospective buyers applying to participate.

In the course of its business, factoring entities generally maintain databases of credit information on many retailers and other entities of the type that may want to participate in auction 5. Accordingly, it is contemplated that factor 30 may already have credit information on a particular prospective buyer. If this is the case, the application step 352 may occur rapidly with a minimum of transaction effort and cost.

If factor 30 does not already have information on the prospective buyer, factor 30 may receive an application fee for performing the credit check. While the credit evaluation may take some amount of time if the prospective buyer is not already in factor's 30 database, it is preferred that the credit check be completed as quickly as practical so that the buyer may participate in auction 5 as soon as possible. In any event, factor 30 may consider the credit application to determine whether the prospective buyer will be approved for participation in auction 5 or rejected therefrom.

If factor 30 rejects the prospective buyer's application, it may notify auction manager 1 as shown in step 354. Auction manager 1 may then notify the rejected prospective buyer as in step 356. The prospective buyer is thus rejected as shown in step 358. It is preferred that auction manager 1 be notified of all rejections so that it may maintain databases in memory 7 (FIG. 1) of prospective buyers should a particular prospective buyer re-apply to participate in auction 5 at some time in the future. To this end, a prospective buyer might be reconsidered in the future should the buyer's credit or other information change such that it meets the requisite credit standards to participate in auction 5.

After the prospective buyer's credit is checked by factor 30, or concurrently with the factor's evaluation of the credit application, auction manager 1 may perform a due diligence step 360 to address the following issue. In today's economy, many retailers and other entities of the type that may participate in auction 5 have billing and shipping addresses that differ. Because of this, it is possible that confusion, mistake or fraud may arise in connection with the delivery and payment of goods or services purchased on the auction 5. For example, if goods purchased at auction 5 are delivered to an address that is different than the address from which payment will be made, the payment address may not actually have firsthand knowledge whether the goods were actually delivered. This could result in goods being properly delivered to a shipping address but the buyer's authorized payment personnel located at another address refusing to pay.

To address this situation, where the prospective buyer's shipping and billing addresses differ, auction manager 1 may perform due diligence 360 to verify the accuracy of both addresses. This due diligence step 360 may also include verification that there is some form of communication channel between the buyer's shipping and billing addresses so that payment for properly delivered goods or services cannot be improperly refused. It is preferred that any such due diligence occur before buyer 50 is allowed to bid on any goods or services posted for auction.

If the prospective buyer is approved, factor 30 preferably sets up a credit limit for buyer 50 and notifies auction manager 1 as shown in step 362. It is preferred that the credit limit be expressed in a maximum amount of “auction dollars” that are available to buyer 50. Auction dollars may simply reflect the amount of buying power that buyer 50 has for an auction 5, regardless of whatever monies buyer 50 may have.

It is preferred that credit limit information be sent to auction manager 1 so that auctions may be run in an orderly manner. For example, when conducting an auction, auction manager 1 may refuse bids from buyers 50 who have exceeded their credit limit. This reflects another aspect of fraud avoidance of the current invention in that winning bids that are excessive and thus have little or no chance of actually being paid, are avoided. At this point, auction manager 1 may then notify buyer 50 that it has been approved and may also advise buyer 50 of the buyer's credit limit as shown in step 364.

Larger buyers 50 with more assets and credit worthiness may benefit from larger credit limits. However, a smaller buyer's credit limit might also increase over time as the buyer displays creditworthiness through timely payment for goods or a series of goods purchased at auction 5. The current invention also contemplates that buyer 50 might also be able to petition factor 30 and/or auction manager 1 for an occasional credit variance to allow buyer 50 to purchase goods or services that exceed the buyer's existing credit limit.

When buyer 50 is notified of its credit limit, buyer 50 may then participate in an auction 5 as shown in step 366. When auction 5 occurs, it is preferred that the posted goods are graphically shown so that buyers 50 bidding thereon have a visual description thereof. Other characteristics of the goods or services may be textually displayed. And if buyer 50 has sound card capability in its computer or other terminal, an audio description may also be provided.

It is preferred that buyers 50 may submit their bids online as the auction 5 progresses. The length of time that the auction may be open for bids may vary. For example, if too few bids have been made, auction manager 1 may keep auction 5 open for a longer time. In any event, a winning buyer 50 will eventually be designated. The winning buyer may generally be the buyer 50 who was the highest bidder. However, the current invention may involve other types of auctions where the winning buyer may not have necessarily submitted the highest bid.

In any event, after the winning buyer has been designated, the type of factoring agreement in place with seller 40 is then considered. As shown in step 370a, a single transaction factoring agreement is involved, and as shown in step 370b, a full service factoring agreement is involved, e.g., no-loan factoring agreement or loan factoring agreement which is typically synonymous with existing clients of factor 30. That is, before a seller 40 may obtain a no-loan or loan factoring agreement covering multiple transactions, it will have developed a good enough track record to be considered a client of the factor as represented by step 328.

If the single transaction factoring agreement 306, 370a is involved, it is preferred that the fees and/or commissions due from seller 40 to auction manager 1 and factor 30 be paid prior to step 372 where information on the designated winning buyer 50 is disclosed. This is preferred to avoid the situation where the winning buyer 50 and seller 40 consummate the transaction by circumventing auction 5 after having received the benefits thereof. Such prepayment may be unnecessary where the seller 50 is an existing client of factor 30 because their existing relationship will generally preclude this surreptitious activity.

In any event, auction manager 1 may then provide seller 40 with the shipping, billing and other necessary information of the highest bidding buyer 50 as shown in step 373. Seller 40 may then ship the auctioned goods or provide the auctioned services to buyer 50 as shown in step 374, and buyer 50 may then receive the auctioned items as shown in step 375.

As also shown in step 375, it is preferred that buyer 50 has some amount of time to evaluate the merchandise before paying for it. This reflects the fraud avoidance aspect of the current invention because this evaluation period allows buyer 50 the time to ensure that the merchandise comports with the merchandise posted during the auction before money actually changes hands. In a preferred embodiment, buyer 50 has thirty days to evaluate the merchandise.

If the merchandise comports with that posted during auction 5, buyer 50 may accept the merchandise as shown in step 376a. Alternatively, the buyer may dispute the merchandise for some reason as in step 376b. As another alternative, buyer 50 may decline the merchandise as in step 376c because it does not comport with the merchandise posted at auction 5.

Factor 30 may become involved where buyer 50 accepts or disputes the merchandise. And as discussed above, the factor's involvement represents a novel aspect of the current invention in that seller 50 benefits from a payment guarantee once the proper goods or services have been delivered. In any event, where buyer 50 accepts the goods or services, the factor's involvement may depend on the type of factoring agreement existing with seller 40.

If a single transaction factoring agreement is involved as shown in step 377, seller 50 has the obligation to collect payment from buyer 50. If this is successful, buyer 50 pays seller 40 directly as shown in step 378a, and the transaction is complete as shown in step 380. If seller 40 cannot collect from buyer 50 within the time specified in the single transaction factoring agreement, factor 30 becomes responsible for payment to seller 40 upon the seller's request as shown in step 378b. At this point, factor 30 pays seller 40 as shown in step 379. But from this payment, the appropriate commission to factor 30 as specified in the single transaction factoring agreement may be deducted. The appropriate commission to auction manager 1 as previously agreed may also be deducted. At this point, the transaction is complete as shown in step 380.

Alternatively, if a no-loan or loan factoring agreement (synonymous with existing clients of factor 30 as discussed above) is involved as shown in step 381, seller 40 need not attempt to collect payment from buyer 50. This is because per the terms of the factoring agreement, buyer 50 directly pays factor 30 within a specified time as shown in step 382a. The specified time for payment from buyer 50 to factor 30 may be specified on the invoice accompanying delivery of the goods or services. If buyer 50 does not timely pay factor 30, the invoice becomes past due as shown in step 382b. This reflects a fraud-avoidance aspect of the current invention in that seller 40 is not burdened with having to expend time and money in trying to collect on the past due invoice 382b.

In either case where buyer 50 timely pays factor 30 as in step 382a or where the invoice becomes past due as in step 382b, factor 30 pays seller 40 as per the factoring agreement in place as shown in step 383. As mentioned above, the appropriate commission to factor 30 as specified in the factoring agreement may be deducted from this payment as may the appropriate commission to auction manager 1 as previously agreed. At this point, the transaction is complete as shown in step 384.

The foregoing represents how the use of a factor in an auction setting is a novel aspect of the current invention. That is, sellers 40 may participate in auction 5 with a reasonable level of confidence that they will get paid regardless of whether the buyer reneges on the deal as in steps 378b or 382b. This is in sharp contrast to the situation where before, sellers faced some amount of risk in selling goods and/or services via an auction because no factor was involved and there was thus no guarantee of getting paid. The use of a factor provides a large practical benefit. That is, because the use of a factor instills a high degree of confidence in the auction 5, more sellers will be attracted to participate in the auction. As a result, the auction becomes more robust with more sellers competing and more commerce occurring.

Still referring to FIG. 2, the scenario 376b where buyer 50 disputes the items delivered after auction 5 is now discussed. As shown, it is preferred that some type of dispute resolution mechanism be provided so that a settlement between seller 40 and buyer 50 may be reached as shown in step 385. For example, auction manager 1 may provide some type of arbitration or mediation mechanism that may be agreed to by both sellers 40 and buyers 50 upon applying to participate in auction 5. The dispute resolution included in the current invention again reflects fraud avoidance.

The current invention contemplates various scenarios to settle such disputes. An example is where buyer 50 returns some portion of the auctioned items to seller 40 as shown in step 386 and some proportion of the original payment amount is agreed upon. This may occur if a portion of the auctioned items are defective or do not otherwise live up to the description posted during the auction. In this scenario, buyer 50 preferably makes a partial payment reflecting the remainder due, i.e., payment for the items not returned. Where a single transaction factoring agreement is involved as shown in step 387, seller 40 may collect the proportional payment from buyer 50 as shown in step 388a and the transaction is complete as shown in step 390.

If buyer 50 fails to pay seller 40 within a specified time as shown in step 388b, factor 30 then becomes responsible for the proportional payment to seller 40. Factor 30 may then pay seller 50 the proportional amount, but as discussed above, the appropriate factoring commission and commission to auction manager 1 may be deducted from this payment. At this point, the transaction is complete as shown in step 390. It should be noted that where settlement 385 was made necessary because seller 40 delivered improper items, the transaction may not do much, if anything, to improve the seller's track record from the viewpoint of factor 30. Accordingly, the transaction may not serve to qualify seller 40 for a full service factoring agreement, e.g., a no-loan or loan factoring agreement.

Another dispute resolution mechanism contemplated by the current invention involves the merchandise being discounted as shown in step 391. This may again be necessary because some or all of the auctioned items were not as good as or otherwise different than the description posted during the auction. In this scenario, buyer 50 preferably makes a partial payment reflecting the discount. Where a no-loan or loan factoring agreement (synonymous with existing clients of factor 30 as discussed above) is involved as shown in step 391, seller 40 need not attempt to collect the partial payment from buyer 50. This is because per the terms of the factoring agreement, buyer 50 pays factor 30 within a specified time directly as shown in step 393a. The specified time for payment from buyer 50 to factor 30 may be specified on the invoice accompanying delivery of the goods or services.

If buyer 50 does not timely pay factor 30, the invoice becomes past due as shown in step 393b and factor 30 then becomes responsible for the proportional payment to seller 40. Factor 30 may then pay seller 40 the proportional amount, but as discussed above, the appropriate factoring commission and commission to auction manager 1 may be deducted from this payment. At this point, the transaction is complete as shown in step 395.

As noted above, where the settlement 385 involving a discount was made necessary because seller 40 delivered improper items, the transaction may not do much, if anything, to improve the seller's track record from the viewpoint of factor 30. Accordingly, the transaction may not serve to qualify seller 40 for a factoring agreement providing more service, e.g., in the case of a no-loan factoring agreement, this transaction would not favor the seller's graduation to a loan factoring agreement.

These scenarios again represent the benefit of the novel use of a factor in the auction setting. That is, even where there is a dispute, the seller 40 is guaranteed at least a partial payment. And the fact that only a partial payment is made may be entirely proper since some of the auctioned items may be of substandard quality or inappropriate for other reasons. Accordingly, the seller's degree of confidence of getting paid because of the factor's involvement may serve to attract more sellers to the auction which in turn provides for more competition and a more robust auction.

These scenarios also again represent the fraud avoidance aspect of the current invention in relation to the buyer. That is, fraud against the buyer is avoided because if the auctioned items were defective or otherwise not fitting the description posted during the auction, it is reasonable for buyer 50 to dispute the auctioned items, return certain items and/or pay a partial or discounted price.

Still referring to FIG. 2, the scenario where the buyer declines the auctioned items as shown in step 376c is now discussed. Here, instead of raising a dispute, buyer 50 may simply decline the auctioned items if they are not as posted during the auction. In this scenario, buyer 50 may return the auctioned items within a certain amount of time, such as thirty days, as shown in step 396. Here, the transaction is not consummated as shown in step 397. This scenario again reflects the fraud avoidance aspect of the current invention in that buyer 50 should not be stuck with items that do not comport with that posted during the auction. Accordingly, fraud on the buyer 50 is avoided.

It is preferred that auction manager 1 and/or factor 30 keep track of the transactions that end up being consummated or not consummated so that the integrity of auction 5 is maintained. For example, if a certain seller 40 repeatedly ships items that are different than those posted during the auction (as in scenario 376c), that particular seller 40 might eventually be expelled from auction 5 or lose its factoring agreement with factor 30.

As another example, if a certain buyer 50 repeatedly disputes items it has purchased (as in scenario 376b), auction manager 1 may investigate whether the disputes are made in good faith. If it turns out that buyer 50 is improperly instigating disputes, this particular buyer 50 might also be expelled from auction 5 or have its credit limit reduced. Instead of being expelled outright, buyers 40 or sellers 50 might alternatively be placed on probation or temporarily suspended from auction 5.

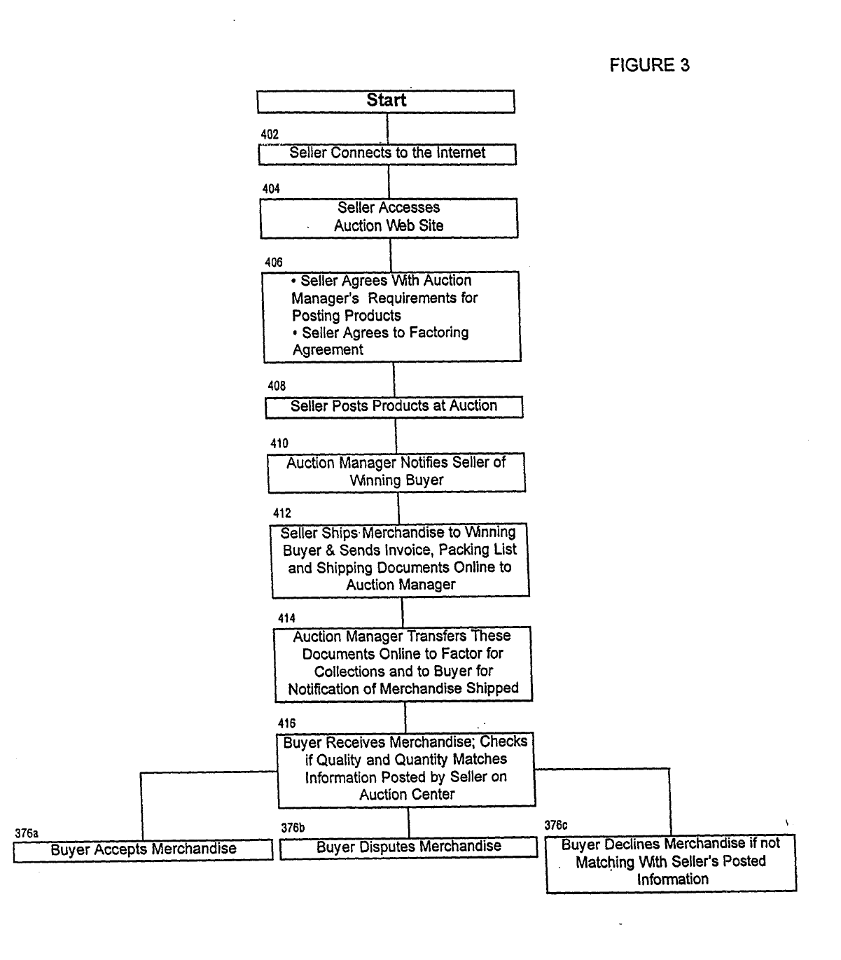

Referring now to FIG. 3, the method of the current invention is shown from the seller's viewpoint starting at step 400. While portions of the following discussion may be similar to the seller's side process 302 discussed in connection with FIG. 2, more detail is provided on points as they concern seller 40.

As shown, a prospective seller may visit the Internet as shown in step 402 and access auction manager's web site 10 as shown in step 404. This is not to say that a prospective seller cannot learn of the auction 5 through alternate, non-Internet means such as other forms of advertising, e.g., direct mail or trade publications relevant to the goods and/or services being auctioned.

Upon visiting the web site 10 of auction manager 1, a prospective seller may preferably view the online agreements to be entered into with auction manager 1 and factor 30. For example, web site 10 may include icons that the prospective seller may click on to call up the auction agreement with auction manager 1 and the factoring agreement with factor 30. The agreements may contain whatever terms are deemed necessary by auction manager 1 and factor 30 such as a minimum posting requirement, delivery times for auctioned items, payment terms and the rate of commission and/or fee to be paid by seller 50.

With respect to factoring agreements, web site 10 may provide samples of the single transaction agreement 306, the no-loan factoring agreement 322 and the loan factoring agreement 330 (FIG. 2) online so that the prospective seller may readily consider what types of factoring options are available. And for prospective sellers that are already clients of factor 30, web site 10 may also include information on how that existing relationship may be used in connection with auction 5.

As shown in step 406, the prospective seller may then submit the appropriate information to apply to become a seller 50 authorized to participate at auction 5, and to apply for the desired factoring agreement. As discussed above, it is preferred that auction manager 1 and factor 30 each have some amount of time in which to review the application in order to determine whether the prospective seller should be allowed to participate in auction 5.

Once seller 50 has become authorized to participate, it may post goods and/or services for auction 5 as shown in step 408. It is preferred that seller 50 post whatever information that is necessary to describe the goods or services being offered. This preferably includes electronics graphical files so that buyers 50 may actually see what they are bidding on.

Auction 5 may then occur and a winning buyer 50 is designated. Depending on the type of factoring agreement in place, auction manager 1 may provide seller 50 with the information on the designated winning buyer 50 as shown in step 410. But as discussed in connection with FIG. 2, in the case of a single transaction factoring agreement 306, this information may not be released to seller 40 until appropriate commissions or fees have been paid to auction manager 1 and factor 30.

At this point, seller 40 ships the auctioned items to the designated winning buyer 50, and the shipping information may also be sent to auction manager 1 and factor 30 as shown in step 412. As mentioned above, this shipping information may include an invoice, packing list and shipping documents. Preferably, this information is sent to auction manager 1 online, but hard copy documents may also be sent. Upon receiving this information, auction manager 1 will be able to determine the commission and/or fee to be forthcoming from seller 40, and may also be able to maintain information on what transactions are occurring on its auction 5.

Depending on the type of factoring agreement 30 in place, seller 40 may then collect payment (in the case of the single transaction agreement 306) or seller may receive payment from factor 30 (in the case of the more full-service type of no-loan or loan factoring agreements 322,330). Where factor 30 will collect payment from buyer 50, auction manager 1 may forward the shipping information to factor 30 as shown in step 414. This preferably occurs online though hard copy documents may also be used. Auction manager 1 may also forward the shipping information from seller 40 to buyer 50 so that buyer 50 knows it submitted the highest bid and will be receiving the auctioned items from seller 40.

At this point, the method may proceed as discussed in connection with the factor's viewpoint in FIG. 2. That is, buyer 50 may accept the auctioned items as shown in step 376a, dispute the auctioned items as shown in step 376b or may decline the auctioned items as shown in step 376c. But in all three scenarios, the risk of fraud against seller 40 is avoided.

For example, where the buyer accepts the auctioned items but does not pay for them as indicated in the scenario represented by steps 376a-380 or 376a-384, seller 40 will receive payment from factor 30 (less any commissions and/or fees due to auction manager 1 and factor 30). And while seller 40 may first have to expend effort in attempting to collect payment in the case of single transaction factoring agreement 306, if buyer 50 does not pay, seller 40 still receives payment from factor 30.

As another example, seller 40 receives at least a partial payment or a discounted, settled payment (less any commissions and/or fees due to auction manager 1 and factor 30) where buyer 50 disputes the auctioned items as indicated in the scenario comprising steps 376b-390 or 375-3965. However, this still reflects fraud-avoidance protection for seller 40 in that though the auctioned items may have been disputed, seller 40 may still participate in any dispute resolution process offered by auction manager 1. Furthermore, that portion of the disputed auctioned items that buyer 50 is not paying for, will be returned to seller 40. Also, it may be that good reason existed for the dispute, in which case it is reasonable for seller 40 to receive payment only for those goods kept by buyer 50, or a discounted payment.

As another example, where the auctioned items are declined by the buyer as shown in the scenario comprising steps 376c-397, the auctioned items are returned to seller 40. And where the auctioned items are declined because they did not match those posted during the auction, it is only reasonable for seller 40 to accept their return.

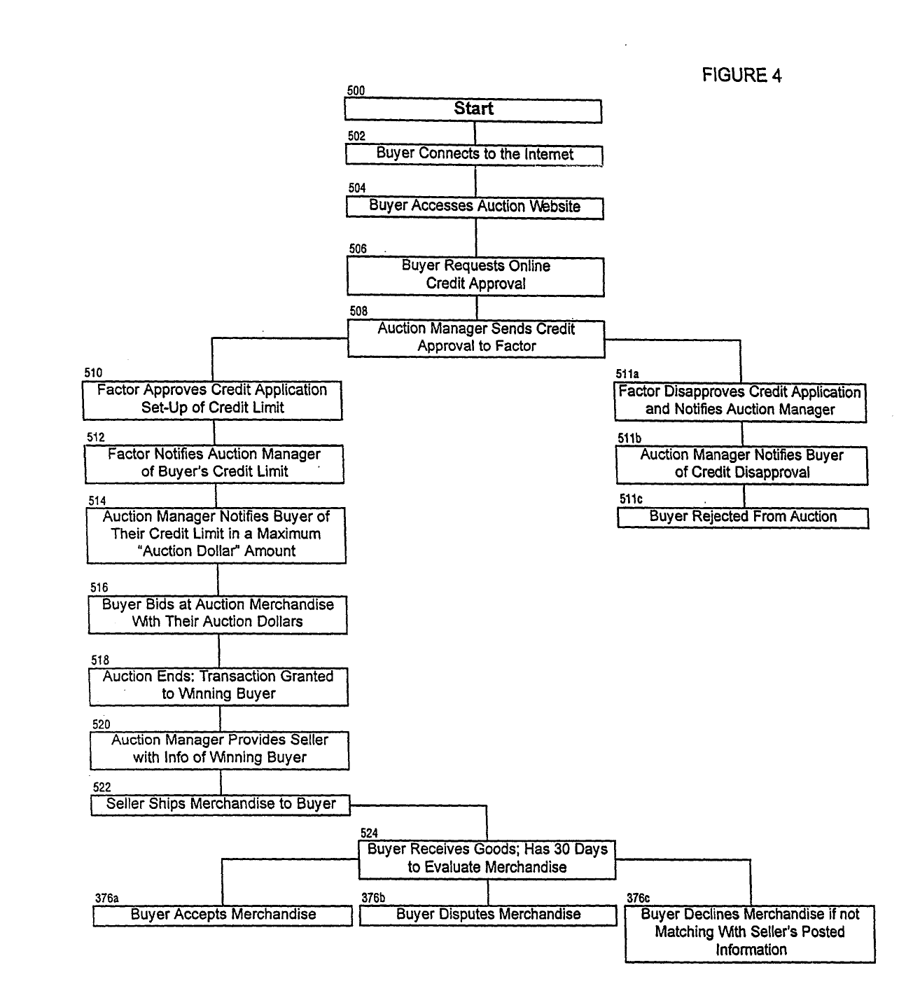

Referring now to FIG. 4, the method of the current invention is shown from the buyer's viewpoint starting at step 500. Again, some of this discussion may be similar to that discussed in connection with FIG. 2, but certain points are expanded upon from the buyer's perspective. A prospective buyer may visit the Internet as shown in step 502 and access the auction manager's web site 10 as shown in step 504. As with the prospective seller, a prospective buyer may learn of the auction 5 through alternate means such as other forms of advertising, e.g., direct mail, trade publications relevant to the goods and/or services being auctioned, etc.

Upon visiting the web site 10 of auction manager 1, a prospective buyer may request credit approval to participate in the auction 1 as shown in step 506. It is preferred that the credit approval request occur online whereby the prospective buyer fills in information into electronic forms appearing on a computer screen. The prospective buyer may thus submit a credit application online to auction manager 1. Alternatively, this may occur with hard copy documents. Upon receiving the prospective buyer's application, auction manager 1 may forward it on to factor 30 as shown in step 508. Alternatively, the credit application may be submitted directly to factor 30. This preferably occurs online though hard copy documents may be used.

As indicated in connection with FIG. 2, for prospective buyers that are existing clients of factor 30, a credit check may be unnecessary. But for buyers that are not clients of factor 30, a credit check fee may be charged and action manager 1 may also perform due diligence checks, e.g., where the buyer's shipping and billing addresses are different.

At this point, both auction manager 1 and factor 30 may have some amount of time to determine whether the prospective buyer should be authorized to participate in auction 5. To this end, factor 30 may perform any type of necessary credit check and other background investigation. Auction manager 1 may also assess the prospective buyer's application to determine whether its needs are in line with goods or services being auctioned at the auction 5.

Factor 30 may then approve the prospective buyer as shown in step 510 or may reject the credit application as shown in steps 511a, 511b and 511c. In the case of rejection, factor 30 may notify auction manager 1 of the rejection as shown in step 511a, and auction manager 1 may then notify the prospective buyer as shown in step 511b. At this point, the buyer is rejected as shown in step 511c. Despite rejection, the prospective buyer may be able to re-apply at some time in the future if its credit situation changes. To this end, it is preferred that auction manager 1 retain information on rejected buyers for future consideration should the buyer re-apply.

If factor 30 approves the buyer's application, a credit limit is set up as shown in step 510. At this point, factor 30 may notify auction manager 1 of the buyer's credit limit for use at the auction 5 as shown in step 512. Auction manager 1 may then notify buyer 50 of the approval as well as the buyer's credit limit of auction dollars as shown in step 514.

As discussed above, the buyer's credit limit is expressed in auction dollars which represents how much buyer 50 may bid on a given auction. However, if buyer 50 has spent some portion of its limit on items in an earlier auction that have not yet been paid for, the buyer's available auction dollars for a subsequent auction may be lowered accordingly. If a buyer 50 attempts to bid more than its available credit, the bid may be denied by auction manager 1. In this manner, auctions may be run in an orderly manner in that buyers 50 cannot submit bids which they cannot likely back up.

Once buyer 50 has become authorized to bid at auctions, it may bid on goods or services posted at the auction 1 as shown in step 516. The auction may then end with a winning bidder being designated as shown in step 518. The winning buyer 50 may be notified by auction manager 1 that is has submitted the winning bid, and auction manager 1 may provide the winning buyer's information to seller 40, as shown in step 520, so that seller 40 may ship the auctioned items as in step 522. But as discussed above buyer 50 and seller 40 may not be notified until after the appropriate fees or commissions have been paid to auction manager 1 and factor 30.

Buyer 50 may then receive the auctioned items as shown in step 524, and may receive some amount of time to evaluate the items. In a preferred embodiment, this time is thirty days which provides buyer 50 with ample time to ensure that the items comport with those posted during the auction. This evaluation period helps avoid fraud perpetrated against buyer 50.

Upon the buyer's receipt of the auctioned items, the method of the current invention may proceed as discussed in connection with the factor's viewpoint of FIG. 2. That is, buyer 50 may accept the auctioned items as shown in step 376a, dispute the auctioned items as shown in step 376b or may decline the auctioned items as shown in step 376c. But in all three scenarios, the risk of fraud against buyer 50 is avoided.

For example, where buyer 50 accepts the auctioned items as indicated in the scenario comprising steps 376a-380 or 376a-384, buyer 50 simply pays seller 40 or factor 30 the appropriate amount and the transaction is complete. In this scenario, buyer 50 accepted the items and simply paid for them. Upon payment, the auction dollars used by buyer 50 for that particular auction are freed up for use in subsequent auctions.

Where buyer 50 accepts the auctioned items but does not pay for them timely as shown in step 378b, 382b, buyer 50 will have to deal with factor 30 in collection proceedings as in step 540. However, this is only reasonable since buyer 50 accepted the auctioned items. It bears reiterating that even where collection proceedings are necessary, seller 40 is still paid by factor 30, as shown by steps 379 and 383 thereby avoiding the risk of fraud on that seller.

Where buyer 50 disputes the auctioned items, it may participate in any dispute resolution procedure that auction manager 1 may provide as shown in the steps following step 376b. One possible settlement that avoids risk to the buyer may involve buyer 50 returning a portion of the auctioned items as shown in the scenario comprising steps 376b-390. Here, buyer 50 is only paying the items that are deemed acceptable and is returning the other items. Alternatively, a dispute may be settled whereby buyer 50 pays a discounted amount as shown in the scenario comprising steps 376b-395. Here, buyer 50 is paying a settled amount which would presumably reflect the real worth of the auctioned items. In either scenario, buyer 50 is protected from having to keep and/or pay full price for auctioned items that differ from or are lesser in value than those posted during the auction.

Where buyer 50 declines the auctioned items as shown in the scenario comprising steps 376c-397, the auctioned items are returned to seller 40 and buyer 50 does not pay for them. Accordingly, buyer 50 is protected against having to keep any auctioned items that differ from what was posted during the auction.

In addition to the auction 5 described above, auction manager 1 may act as a coordinator 1002 (FIG. 5) and may provide or coordinate other services and benefits. Referring now to FIGS. 5-8, other services and aspects of the current invention are now described.

For example, coordinator 1002 may provide an innovative financing method 1001 for use by buyers (retailers or other distributors) 1006 to purchase goods or services from sellers (suppliers or manufacturers) 1005. The terms buyers, retailers and distributors are used interchangeably herein with respect to reference numeral 1006. The terms sellers, manufacturers and suppliers are also used interchangeably with respect to reference numeral 1005. Financing method 1001 may also involve financial institutions such as banks 1003, factors 1004 or other institutions that provide services such as asset management, securities trading, financing and leasing capital, loans, advances, credit guarantees and accounts receivable management. The financing method 1001 may be used where the retailers 1006, suppliers 1005, banks 1003 and other financial institutions 1004 are all located in the same country, as well as in different countries.

As discussed later, buyers 1006 participating in financing method 1001 may generally have pre-approved credit to purchase goods or services offered by sellers or suppliers 1005. This may occur by the buyer 1006 placing a purchase order with coordinator 1002 which in turn seeks credit approval for buyer 1006 from factor 1004.

As such, a benefit of financing method 1001 is that letters of credit may be eliminated. This is advantageous since letters of credit typically require time to arrange, which may in turn delay or otherwise adversely affect sales transactions. This is especially so where transactions involve suppliers 1005 and retailers 1006 that are located in different countries. That is, language and cultural differences may slow down an already burdensome process of obtaining an LC.

FIG. 5 generally depicts the arrangement, network or other configuration of the financing method 1001 and the entities. As shown, financing method 1001 generally involves a coordinator 1002 (which may be an entity that is the same as or similar to auction manager 1), a bank or other similar financial institution 1003, a financial institution such as a credit or factoring company 1004, one or more manufacturers or other types of suppliers or sellers 1005 and one or more retailers or other types of distributors or buyers 1006.

Coordinator 1002 may communicate with the various participating entities through electronic transmissions over the Internet or other network. Such electronic connectivity is preferred to reduce transactional costs and increases efficiency. The entities may be electronically connected by links 1010a, 1010b, 1011 and 1012 as shown in FIG. 5. As discussed below, these reference numerals may also refer to contracts, agreements or other types of relationships between the pertinent entities.

Other means of communication, e.g., telephone, mail, fax, etc., may be used between the participating entities. Furthermore, for various steps in financing method 1001, the participating entities may communicate with each other without necessarily going through coordinator 1002. Though such lines of communication are not shown in FIG. 5, they may comprise Internet or other network connections or other type of communication means.

The financing method 1001 of the current invention is generally applicable to the purchase and distribution of various types of merchandise or services, including one-off sales transactions. To the extent that the following discussion refers to certain types of goods or services, it should be noted that this is not intended to limit the scope of the current invention. The financing method 1001 of the current invention may be used in connection with overseas or domestic suppliers 1005 and retailers 1006. Similarly, domestic or overseas banks 1003 and other types of financial institutions 1004 may participate in financing method 1001. As such, financing method 1001 preferably avoids delays associated with obtaining letters of credit due to language or cultural differences.

The function of coordinator 1002 is now further discussed. As its name implies, coordinator 1002 preferably serves an overall coordinating function between the other entities involved in financing method 1001. To this end, coordinator 1002 may generally provide a marketplace for multiple buyers and sellers to transact business, including one-off sales transactions.

Coordinator 1002 may maintain a web site 1050 that is accessible to suppliers 1005 and retailers 1006, as well as accessible to other entities including bank 1003 and factor 1004. The web site 1050 may include a sub page 1052 that is devoted to transactions using the financing method 1001 of the current invention. The home page of web site 1050 may include an icon or link that may be clicked on by an inquiring entity to visit the appropriate sub page 1052 for a description of financing method 1001.

The coordinator's web site 1050 may also include a server 1054 and memory 1056 or other suitable devices for maintaining databases of information. Such databases may contain information related to the entities participating in, and transactions consummated by, financing method 1001. Server 1054 may also contain appropriate databases and tracking means to track the progress and status of transactions occurring over web site 1050 and/or using financing method 1001. It should be noted that the configuration of coordinator 1002 is for illustrative purposes and is not intended to limit the scope of the invention.

Besides coordinating the financing method 1001, coordinator 1002 and its web site 1050 may provide other coordinating-type services. For example, coordinator 1002 may generally bring buyers (such as retailers 1006) and sellers (such as suppliers 1005) of goods and services together so that they may transact business in the first place. To this end, coordinator 1002 may provide an Internet sourcing network 1060, a virtual trade show 1062 and web design and hosting services 1064. These other services are now briefly discussed before further description of financing method 1001.

The Internet sourcing network 1060 may generally provide a business-to-business e-commerce solution that streamlines the manner in which retailers 1006 may locate suppliers 1005 of goods or services. To this end, the Internet sourcing network may generally comprise a series of private extranets, with each private extranet being specific to a given retailer 1006. The extranets may be built and maintained by coordinator 1002. It should be noted that an extranet may be semi-private for use by more than one retailer 1006, or may be public for use by various retailers 1006 or other entities.

Each retailer's private extranet preferably provides the retailer 1006 with access to various suppliers 1005 that participate with coordinator 1002. It is preferred that this access includes visual access to the goods or services of the supplier 1005. For example, coordinator 1002 may provide images of supplies' goods to retailers 1006. Alternatively, coordinator 1002 may provide retailers 1006 with links to suppliers' web sites or other visual display of suppliers' goods or services. In this manner, buyer/retailer 1006 may actually see the goods or services it is contemplating buying.

A benefit of the visual access provided by coordinator 1002 is the reduction in time that a retailer 1006 may typically need to spend in sourcing and choosing goods or services that it will purchase and then resell. For example, the time necessary for a retailer 1006 to physically visit and inspect merchandise in supplier showrooms or in the market may take a significant amount of time. This situation is exacerbated where the goods or services of multiple suppliers may need to be inspected at various locations. This situation is even more exacerbated where the supplier 1005 and retailer 1006 are located in different countries where issues such as time differences, language barriers and business travel costs may inhibit commerce. However, by coordinator 1002 providing visual access to the goods and services of various suppliers 1006 through web site 1050, the amount of time necessary to make sourcing decisions may be drastically reduced.

Because Internet access may be limited in certain countries around the world, it is preferred that coordinator 1002 also provide locations at which suppliers 1005 or retailers 1006 may gain access to the Internet to participate in the e-commerce solutions offered by the current invention. This may occur through establishing joint ventures with companies in other countries, wherein the joint venture provides Internet access. Such joint ventures may include relationships with Internet portals and the like. To this end, coordinator 1002, its joint ventures or some other entity preferably provide the web site design and hosting services 1064 discussed in more detail below.

Besides reducing the time necessary to locate goods or services, the time savings benefit provided by the coordinator's web site 1050 also extends to the time necessary to consummate transactions. For example, in conventional buyer/supplier relationships, one or more face-to-face meetings may typically be necessary. This may take significant time especially if the buyer and supplier are located in different countries. However, the e-commerce solution provided by facilitator 1002 may greatly reduce or eliminate the need for such meetings so that goods or services may be sourced and re-sold at market more quickly.

Yet another benefit of providing retailers 1006 with access to suppliers 1005 is the general increase in commerce that is stimulated through the retailer/supplier forum provided by coordinator 1002. That is, retailers 1006 participating through web site 1050 will preferably be exposed to more suppliers 1005 thereby creating additional buying opportunities. This in turn preferably allows retailers 1006 to build their product sourcing bases and lower prices to increase profit margins by establishing direct sourcing relationships. This general increase in commerce is also aided by the financing method 1001 discussed later.

A given retailer's extranet may be designed for that specific retailer's needs, e.g., a given retailer 1006 may receive information about only those suppliers 1005 that meet the retailer's market needs. Accordingly, the Internet sourcing network 1060 may provide a significant time and cost savings in locating appropriate suppliers by centralizing a retailer's sourcing and review of prospective goods and services to one location, i.e., coordinator's web site 1050.

The Internet sourcing network 1060 also preferably allows a retailer 1006 to privately conduct business with the suppliers 1005 it comes into contact with. It is also preferred that a retailer's needs may be broadcast over its extranet to reach all those suppliers that may possibly supply the desired goods or services. That is, the Internet sourcing network 1060 preferably provides a retailer 1006 with the ability to broadcast “open-to-buy” orders to all or an appropriate group of suppliers 1005 participating in the network. Transactions over the Internet sourcing network 1060 may involve the financing method 1001 discussed in more detail herein.

Coordinator 1002 may charge a transaction fee or other type of fee to retailers 1006 for access to the Internet sourcing network and the other services provided by coordinator 1002. For example, retailer 1006 may be charged a fee for each purchase of goods or services it consummates via coordinator 1002. This transaction fee may be 5% or some other percentage of the purchase amount. Accordingly, the current invention also includes a method of generating revenue.

Suppliers 1005 may also participate in the Internet sourcing network 1060. To this end, the coordinator's web site 1050 may provide a supplier 1005 with direct access to retailers 1006 that may be in the market for the types of goods or services offered by that particular supplier 1005. Furthermore, participation in the Internet sourcing network 1060 also preferably provides suppliers 1005 with the ability to receive the broadcast open-to-buy orders mentioned above.

By coming into contact with multiple retailers 1006 over the coordinator's web site 1050, a particular supplier 1005 preferably gains foresight into the buying needs and procurement cycles of various retailers. Accordingly, suppliers 1005 are provided with the ability to alter their product lines to suit various retailers 1006. Furthermore, this may occur in real-time by virtue of communication over the Internet. As mentioned above, transactions occurring over the Internet sourcing network 1060 may involve financing method 1001.

Coordinator 1002 may charge a set-up fee, subscription fee or other type of fee to suppliers 1005 for this access. For example, a one-time set-up fee may be charged to supplier 1005 to gain access to coordinator's services. Thereafter, a subscription fee may be charged on a monthly, annual or other basis. Accordingly, the current invention also includes a method of generating revenue in this manner.

As another service, coordinator 1002 may also provide the virtual trade show 1062 through its web site 1050. Virtual trade show 1062 may generally comprise a listing of goods or services that are available from suppliers 1005 to retailers 1006 through coordinator's web site 1050. It is preferred that the virtual trade show provide visual access regarding the goods and services offered. It is preferred that retailers 1006 may easily search for different goods or services via the virtual trade show 1062. In this manner, the virtual trade show 1062 enables suppliers 1005 to direct market their goods or services to the universe of buyer/retailers 1006 that participate with coordinator 1002. Financing method 1001 may be used to consummate transactions occurring via the virtual trade show 1062. Coordinator 1002 may also provide web design and hosting services 1064 through its web site 1050. This may be especially beneficial to small and medium sized entities that do not have the financial resources to hire a web design firm to build a web site. Coordinator 1002 may provide a free template web page and shared domain name. Coordinator 1002 may also provide fee-based customized web design and hosting services as well.

As discussed earlier, coordinator 1002 may also provide the auction 5 that is shown in FIG. 1 (and FIG. 5). Auction 5 may also serve as a forum for coordinator 1002 to bring suppliers 1005 and retailers 1006 together in connection with the financing method 1001 described herein. To this end, the web site 10 shown in FIG. 1 and the web site 1050 shown in FIG. 5 may comprise the same web site with different and/or a combination of sub pages being devoted to auction 5 and financing method 1001. Accordingly, an aspect of the current invention is the combination of the financing method 1001 with the wholesale auction 5, or with the coordinator's other services such as those described above.

To support the foregoing services, software and other technology is preferably used. For example, a product-driven search engine may be used which locates products by product type. This overcomes significant drawbacks of current search engines that function based on key word searches that are impractical for business-to-business e-commerce where product or service type is the more appropriate searching basis. This product-based search engine is preferably linked to dynamic listings of supplier product catalogs and line sheets that may include detailed product descriptions and digital photographs. These products are preferably indexed and separated into easily recognizable categories which facilitates quick products searches by retailers 1006.

The coordinator's services may also be supported by software that allows retailers 1006 to create individual and customized profiles of its buying interests that specify only those products or services it is interested in. This allows a retailer 1006 to search for suppliers 1005 via the coordinator's web site 1050 that provide only those goods or services of interest. This is advantageous because it avoids unnecessary searching or other investigation into suppliers that do not offer goods or services sought by retailer 1006.

With this software, a retailer 1006 may first create a customized profile that will be used when searching the database of suppliers 1005 that interface with the coordinator's web site 1050. When retailer 1006 searches for goods or services, the software “pushes” or broadcasts all goods or services of interest that are accessed by the coordinator's database to retailer 1006. To this end, all goods or services that match the retailer's profile will be retrieved from memory 1056, or from the supplier's separate web sites, and transmitted to the retailer's buyer's desktop.

For example, retailer 1006 may be interested in men's jeans. In this case, retailer 1006 may create a customized profile specifying that interest. When a buyer working for retailer 1006 then searches coordinator's web site, the software preferably transmits all or some portion of the information and images stored in its databases to the buyer regarding men's jeans.

The coordinator's services may also be supported by software that allows those retailers 1006 and suppliers 1005 participating in the coordinator's Internet sourcing network 1060 to conduct various interactive functions. Generally, this software may allow suppliers 1005 and retailers 1006 to transact business more efficiently. This in turn provides the retailers 1006 and suppliers 1005 that use coordinator's web site 1050 and services with the competitive edge associated with rapid responses to supplier and retailer needs.

Retailers 1006 may use this software to maneuver and manipulate the product information contained within the retailer's product database. For example, this software preferably allows a retailer 1006 to delete, restore or otherwise modify the products listed as being of interest in that retailer's profile. This software also preferably allows retailers 1006 to transmit bulk or personal e-mails or other communications to appropriate suppliers 1005 participating in the Internet sourcing network. These communications may include the “open-to-buy” orders mentioned above, special product requests, announcements that convey the retailer's buying and planning goals and other types of messages. This software may also be used to notify retailers 1006 of when a supplier 1005 may be offering a new, close-out price or other type of special deal on goods or services that correspond with the goods or services specified in a retailer's profile.

Suppliers 1005 may use this software to remotely change, upload, delete or otherwise modify the product information that is made accessible to retailers 1006 based on product requests submitted by retailers 1006. Suppliers 1005 may also use this software to receive retailer announcements as to retailer needs, etc.

Besides the services discussed above, coordinator 1002 may also provide other services and functions to suppliers 1005 and retailers 1006 in connection with the current invention. For example, coordinator 1002 may receive orders from retailers 1006 and then forward and place those orders with suppliers 1005. As another example, coordinator 1002 may also provide or arrange for credit approval of retailers 1006. As yet another example, coordinator 1002 may also investigate into the viability and quality of the goods or services provided by the suppliers 1005.

Now that various of services of coordinator 1002 have been discussed, the financing method 1001 of the current invention is now explained in more detail. The relationships between coordinator 1002 and the various participating entities, as well as how these relationships may come into existence, are first discussed.

Coordinator 1002 may engage an appropriate bank 1003 to provide funding for transactions that involve financing method 1001. For example, bank 1003 preferably provides advance payments or loans to a supplier 1005 against the amount due. To this end, bank 1003 may provide factoring services on the account receivables of such suppliers 1005. Bank 1003 may also be engaged to fund or participate in other transactions that occur through the coordinator's web site 1050.

Coordinator 1002 may engage an appropriate factor or other financial institution 1004 to conduct credit checks and credit guarantees of prospective buyers or retailers 1006 and to generally provide factoring services on the accounts receivables based on sales made by sellers or suppliers 1005. As part of financing method 1001, factor 1004 may also guarantee payment to bank 1003 so that bank 1003 is in a position to provide the advance payment or loans to suppliers 1005 mentioned above. This in turn provides suppliers 1005 with accounts receivable funding to finance a supplier's cash flow needs.

With respect to how suppliers 1005 may come to participate in financing method 1001, one avenue is that a supplier 1005 may already be engaged with coordinator 1002 in connection with the coordinator's other services, e.g., Internet sourcing network 1060, auction 5, virtual trade show 1062 and/or web design and hosting 1064. By virtue of this pre-existing relationship, suppliers 1005 may become aware of financing method 1001 and elect to participate therein as shown by relationship 1011 in FIG. 5.

As another avenue to participation in financing method 1001, suppliers 1005 that are not already involved with coordinator 1002 may still contact coordinator 1002 through web site 1050 (or otherwise) to inquire about financing method 1001. This may result from coordinator 1002 advertising the financing method 1001 over the Internet or through other media. To this end, suppliers 1005 may contact coordinator 1002 about the potential buyers of the suppliers' products or services, and about the different types of markets, e.g., wholesale or retail, that the suppliers' products or services may be distributed in. Alternatively, coordinator 1002 may contact suppliers 1005 to participate in financing method 1001.

In the manners discussed above, a plurality of vendors preferably come to participate in the marketplace provided by coordinator 1002. As explained in the background section, current international factoring arrangements generally do not accommodate this situation involving a plurality of vendors. However, this situation is addressed by financing method 1001 as discussed below.

A contractual or other type of arrangement 1011 may exist between coordinator 1002 and suppliers 1005. Pursuant to the arrangement 1011, suppliers 1005 may then sell or otherwise provide products or services to retailers 1006 by using financing method 1001. The coordinator/supplier relationship 1011 may also come to encompass other services provided by coordinator 1002.

In similar fashion to suppliers 1005, retailers 1006 may come to participate in the marketplace provided by coordinator 1002 and financing method 1001 by virtue of having already participated in the other services offered by coordinator 1002. Alternatively, retailers 1006 may contact coordinator 1002 to inquire (shown as 1012 in FIG. 5) about participating in financing method 1001 and about sources of products or services that retailers 1006 may then resell. Alternatively, coordinator 1002 may contact prospective retailers to participate in financing method 1001.

A contractual or other type of arrangement 1012 may be reached between coordinator 1002 and retailers 1006. Such an arrangement may be contingent on restrictions or other conditions such as a retailer 1006 receiving a credit line approval. Pursuant to the arrangement 1012, retailers 1006 may become approved to participate in the financing method 1001, and may then purchase or otherwise acquire products or services through coordinator 1002 for resale.

The coordinator's relationship or agreement 1011 with suppliers 1005 and relationship or agreement 1012 with retailers 1006 may also be entered into in document form. Alternatively, the agreements 1011, 1012 maybe displayed on coordinator's web site 1050 so that they may be entered into electronically. This preferably allows prospective suppliers 1005 and retailers 1006 that desire to participate in financing method 1001 to view the agreement 1010 on the coordinator's web site 1050 and agree to its terms by simply clicking on an “I accept” or other similar button.

The agreements or relationships 1011, 1012 preferably contemplate that suppliers 1005 and retailers 1006 use the services offered by bank 1003 and factor 1004 in connection with financing method 1001. To this end, participation in financing method 1001 may be contingent on this. Such services preferably include lending services by bank 1003 and factoring services by factor 1004.

The relationship between coordinator 1002 with bank 1003 and factor 1004 is now discussed in more detail. To effect financing method 1001, the current invention contemplates that a contract, agreement or some other type of relationship 1010a be established between coordinator 1002 and bank 1003. The current invention also contemplates that a contract, agreement or some other type of relationship 1010b be established between coordinator 1002 and factor 1004. Preferably, agreements or relationships 1010a,b comprise an overall tri-party assignment agreement 1010 between coordinator 1002, bank 1003 and factor 1004 which establishes the relationships between all three parties.

However, it should be noted that separate coordinator/bank 1010a and coordinator/factor 1010b agreements may be entered into to achieve the desired tri-party assignment agreement. In this case, it is preferred that all three parties be aware of both agreements so that all the parties' obligations thereunder are known.

The tri-party assignment agreement 1010 may be executed in document form. Alternatively, the assignment agreement 1010 may appear on the web site 1050 of the coordinator 1002, or may be otherwise electronically available. This preferably allows prospective banks 1003 or factors 1004 seeking to participate in financing method 1001 to view the assignment agreement 1010 on the coordinator's web site 1050 and agree to its terms by simply clicking on an “I accept” or other similar button. Separate agreements 1010 may be entered into for each combination of bank 1003 and factor 1004 that wish to participate in financing method 1001.

The terms of the tri-party assignment agreement 1010 are now further discussed, with the terms 1010b that pertain primarily as between coordinator 1002 and factor 1004 being discussed first. The terms or conditions 1010b may generally include a factoring agreement. Generally, the process of factoring involves a first entity assigning its accounts receivables to a second entity for collection by the second entity. The second entity pays the first entity the amount of the assigned accounts receivable less some amount or fee for undergoing the risk of collection, i.e., the risk of nonpayment or payment after protracted efforts. In a preferred embodiment, agreement 1010b reflects a non-recourse factoring arrangement. This generally means that factor 1004 is actually assuming the risk of collection rather than coordinator 1002. However, financing method 1001 is not necessarily limited to non-recourse collection.

In general, it should be noted that the terms or conditions of the tri-party assignment agreement 1010 discussed herein are not exclusive of other types of terms or conditions that may generally provide for financing method 1001. Accordingly, the scope of the current invention is not limited to the following terms or conditions.

In the tri-party assignment agreement 1010 of the current invention, agreement 1010b contemplates that coordinator 1002 assign or otherwise transfer accounts receivables to factor 1004 for collection by factor 1004. The exact terms and conditions of this assignment may vary. But financing method 1001 contemplates that the accounts receivables assigned or transferred from coordinator 1002 to factor 1004 originally arise out of orders for goods or services placed by retailers 1006 to suppliers 1005 through coordinator 1002.

More specifically, a retailer 1006 negotiates a transaction with a seller 1005 and then places an order reflecting this transaction with coordinator 1002. This creates an account receivable in the coordinator's favor. This order may be subject to various terms such as net 30 payment. Coordinator 1002 then places a “mirror” order to the supplier 1005 specified by retailer 1006 thereby creating an account receivable in the supplier's favor. In any event, the account receivable in favor of coordinator 1002 is assigned to factor 1004 per agreement 1010b.

It is preferred that before a retailer 1006 may participate in financing method 1001, the retailer's credit be approved. To this end, coordinator/factor agreement 1010b may specify that coordinator 1002 refers retailer credit approval requests to factor 1004. The coordinator's obligation to refer these requests to factor 1004 may be exclusive or non-exclusive. To the extent that it is non-exclusive, coordinator 1002 may enter into multiple agreements 1010b with multiple factors 1004.

In keeping with the automated and time-efficient services provided by coordinator 1002, it is preferred that requests for retailer credit approval be transmitted to factor 1004 electronically. To this end, retailer credit approval requests may be sent via online terminal access or through electronic batch transmission. Alternatively, these requests may be transmitted over the phone, by fax, in writing or by other appropriate means. It is also preferred that the factor's decisions on whether to approve or reject the request be transmitted to coordinator 1002. This may occur through electronic reports or other appropriate means.

To increase the number of retailers using the coordinator's marketplace and financing method 1001, it is preferred that factor 1004 timely provide feedback on credit approval requests. To this end, coordinator/factor agreement 1010b may provide a specific timeframe for factor 1004 to respond to a credit approval request. Should there be any disputes regarding credit approval, agreement 1010b may include a provision for dispute resolution. Agreement 1010b may also specify that a fee is charged for each credit approval request.

Agreement 1010b may also specify limitations and restrictions on the amount and type of credit being approved. For example, factor 1004 may approve different retailers 1006 for different levels of credit depending on each retailer's credit risk. Also, factor 1004 may specify that the credit approval is valid only for a certain time period after approval is given. This preferably avoids the situation where the retailer's financial condition drastically changes by the time ordered goods or services are shipped and need to be paid for. To this end, periodic credit checks may be performed.

Agreement 1010b may also specify the parameters of the risk being assumed by factor 1004 when accepting accounts receivables from coordinator 1002. For example, agreement 1010b may specify that factor 1004 assumes only the risk of nonpayment due to the retailer's financial inability to pay. In this case, if there is a change in the amount, shipping date, delivery date or other terms surrounding a transaction, agreement 1010b may provide that factor 1004 has the option of retaining the risk or allocating it back to coordinator 1002. Other risk parameters and terms of collection may also be addressed in agreement 1010b such as those discussed in connection with the factoring feature provided for in auction 5.

Agreement 1010b may also set forth the factor's purchase price for the accounts receivable obtained from coordinator 1002. For example, agreement 1010b may provide that factor 1010b pays coordinator 1002 the gross amount of the invoice less factoring fees or charges, trade or cash discounts taken by retailers 1006, as well as other fees or charges such as interest that coordinator 1002 and factor 1004 may agree upon, or deductions that reflect disputes between buyer 1006 and seller 1005. Agreement 1010b may also specify that coordinator 1002 is paid a fee or “mark-up” (which is part of the account receivable assigned to factor 1004) for arranging the transaction.

Agreement 1010b may also set forth terms regarding how payment is made to the factor 1004 for the accounts receivables obtained from coordinator 1002. To facilitate payments being made to factor 1004, invoices for the goods or services sold through financing method 1001 preferably include a legend or other designation that the account receivable has been assigned to factor 1004, and that payment is to be made thereto. Agreement 1010b may create an obligation to so designate invoices or other comparable paperwork or electronic notice sent to buyer 1006. Furthermore, the terms of the buyer/coordinator agreement 1012 under which retailer 1006 orders goods from coordinator 1002 may specify that payment will eventually be made directly to factor 1004.

To address disputes with respect to the amount owed by retailer 1006, e.g., where the goods or services received are not in accordance with that ordered, where goods are returned, etc., the agreement between buyer 1006 and seller 1005 may provide that coordinator 1002 is to inform factor 1004 of changes so that the account receivable assigned to the factor 1004 may be adjusted. However, factor 1004 may also deal directly with retailers 1006 on such matters. Agreement 1010b may also provide that as the owner of the accounts receivables, factor 1004 may bring suit, enforce collection and perform other tasks necessary to collect on the accounts receivables.

Agreement 1010b may also provide that coordinator 1002 assigns a continuing security interest in certain or any rights it may have in the accounts receivables from retailer that are assigned to factor 1004. This may include any other rights that coordinator 1002 may have in connection with the transactions giving rise to the accounts receivables, e.g., rights to inventory, insurance proceeds, etc.

The agreement 1010a that primarily addresses the relationship between coordinator 1002 and bank 1003 is now discussed in further detail. As noted above, it is preferred that factor 1004 is aware of the terms and conditions in agreement 1010b. In this manner, all three entities, i.e., coordinator 1002, bank 1003 and factor 1004, may proceed with knowledge of each party's obligations as under the tri-party assignment agreement 1010.

Generally, agreement 1010a may provide that bank 1003 has a security interest in the monies due to coordinator 1002 under the coordinator/factor agreement 1010b. The exact amount of the security interest may be expressed in various manners such as a percentage of the monies due to coordinator 1002 under agreement 1010b. The percentage of the interest assigned to bank 1003 may vary as agreed upon by coordinator 1002 and bank 1003, and perhaps factor 1004. The security interest may alternatively be expressed as an amount which reflects the amount of the account receivable less certain deductions.

Agreement 1010a may also direct factor 1004 to remit payment to bank 1003 upon factor 1004 collecting payment on the accounts receivable assigned to it by coordinator 1002. Based on this obligation by factor 1004, and because factor 1004 is essentially guaranteeing the buyer/retailer's credit, bank 1003 may thus be in the position where it advances or loans a portion of the money due to supplier 1005, before the money is actually all collected from retailer 1006. Such advances or loans provide cash flow certainty to supplier 1005 since it will receive an advance or loan before collection is actually made.

Agreement 1010a may also specify that coordinator 1002 is to be paid some percentage of mark-up upon the factor's collection on an account receivable. The mark-up is discussed further below, but may generally represent a profit by the coordinator for arranging a transaction between a supplier 1005 and a retailer 1006.

Agreement 1010a may also provide that bank 1003 advance or loan some percentage of the supplier's invoice (based on the sale from supplier 1005 to coordinator 1002) as mentioned above. For example, agreement 1010a may provide that this advance or loan is to be 80% of suppliers' invoices to coordinator 1002. However, the current invention contemplates other percentages as well. The percentages advanced to different suppliers may vary.

A primary benefit of financing method 1001 with the use of tri-party assignment agreement 1010 is that the need for a LC is eliminated. Accordingly, all the risks and downsides facing the buyer 1006 or seller 1005 as discussed in the background section are avoided. Another benefit of financing method 1001 is that supplier 1005 may receive advances or loans against its accounts receivables for the goods or services it sells to buyer 1006.

The benefits of financing method 1001 and its differences from current international factoring methods are now further discussed. Where supplier 1005 is located in a foreign country and buyer 1006 is located domestically (or vice versa), a single financial institution located domestically (such as factor 1004) cannot easily and efficiently advance or loan money to the foreign supplier 1005. This is because before any advance or loan would be made, the domestic financial institution would need to assure itself that it would receive payment back on the advance or loan. Without such assurance, it would make little business sense to provide risky loans or advances.

Also before providing any such advance or loan, the domestic financial institution would need to perfect its legal position should the foreign supplier 1005 not readily pay back the advance or loan. That is, the domestic financial institution would need to place itself in a legal or priority position to demand the money back should the advance or loan remain unpaid.

However, obtaining assurances that the advance would be paid back would require significant investigation into the foreign supplier's financial viability and track record of shipping quality merchandise. And because suppliers 1005 may be located in various foreign countries, obtaining this type of information may not be readily available without significant effort. The amount of effort necessary to obtain assurances would be increased significantly where hundred or thousands of foreign suppliers are involved. Expending such effort would make little business sense, especially for one-off sales transactions. Because of this, current international factoring arrangements are generally limited to a single overseas supplier. This severely limits the potential sources of goods or services.

Also, a factor's perfecting its legal position in another country could likewise be difficult. For example, various foreign countries typically have differing legal requirements regarding what would be necessary for the domestic financial institution to become a creditor that would be in the first (or other priority) position to collect on the advance or otherwise perfect its legal position. To research and follow these various requirements would also involve significant expense and effort. And again, the expense and effort would be significantly increased where many different countries are involved. Again, expending such effort would make little business sense, especially for one-off sales transactions. Because of this, current international factoring arrangements are generally limited to a single supplier thereby severely limiting potential sources of goods or services.

To address the foregoing issues, financing method 1001 serves to avoid the significant effort that would need to be expended by a financial institution (such as a factor) to provide services whereby multiple sellers that may be located in various foreign countries are involved. As such, financing method 1001 makes possible a marketplace that includes numerous sellers and that provides for factoring services to buyers 1006 and loans or advances to sellers 1005.

To alleviate the effort that would be needed for a factor to perfect its legal position with respect to any loans or advances made against account receivables, agreement 1010a of tri-party assignment agreement 1010 provides that all accounts receivables are assigned to factor 1004 from coordinator 1002. Accordingly, factor 1004 need not attempt to perfect its legal position for multiple sellers in possibly multiple foreign countries. Instead, it may perfect its legal position with respect to coordinator 1002. And even though the accounts receivables are assigned from coordinator 1002, coordinator 1002 is still dealing with numerous sellers 1005 thereby allowing the marketplace to benefit from a variety of sources of goods or services, and to make one-off transactions feasible.

To alleviate the effort necessary to investigate foreign sellers, financing method 1001 includes one or more financial institutions in other countries such as banks 1003 that have better access to information regarding foreign suppliers' financial viability and track record of shipping quality merchandise. And to the extent necessary, such overseas banks 1003 also have familiarity with the laws and requirements in their respective countries regarding the perfection of legal positions that they may have to take on loans or advances provided to sellers 1005. Accordingly, foreign financial institutions 1003 are included in financing method 1001 so that they may provide suppliers 1005 with advances or loans.

With financing method 1001 and the tri-party agreement 1010, the goods or services from a foreign supplier 1005 are sold to coordinator 1002 (which may be located in the same country as factor 1004). Coordinator 1002 then sells the goods or services to the domestic buyer 1006 and also assigns the corresponding account receivable to factor 1004. In this manner, factor 1004 may easily perfect its legal position because it may obtain the first (or priority) position with respect to the coordinator's account receivable thereby alleviating the foregoing issues associated with foreign suppliers.

In similar fashion, the foreign bank's familiarity with the laws of its country will preferably allow it to perfect its legal position regarding the advances it provides to foreign supplier 1005. To this end, and as discussed later, bank 1003 may generally have a collection-type relationship with supplier 1005. Furthermore, bank 1003 will not need to investigate the creditworthiness of the domestic buyers 1006 that are purchasing the supplier's 1005 goods or services. This is because under the tri-party agreement 1010, factor 1004 is guaranteeing payment to bank 1003.

As shown by the foregoing, international transactions pose significant hurdles to financial institutions that seek to participate in them. However, financing method 1001 of the current invention overcomes these hurdles because the coordination provided by coordinator 1002 allows both the domestic factor 1004 and the overseas bank 1003 to participate in international trade without forcing them to undergo expensive and time consuming investigations into the creditworthiness of companies located in other countries, or into the laws of other countries. The burdens of perfecting multiple legal positions in possibly multiple foreign countries are also avoided.

The benefits of the financing method 1001 to retailers 1006 is now further described. To promote such benefits, coordinator 1002 may advertise or otherwise promote the financing method 1001 through its web site 1050. Alternative means of promotion may be used as well.

A primary benefit of financing method 1001 is the retailer need not obtain traditional letters of credit. The burdens and risks associated with obtaining them are thus avoided. This is especially beneficial for international transactions where letters of credit have been a predominant means of payment. With financing method 1001, sellers 1005 may thus more easily sell to pre-approved buyers 1006. Administrative expenses and burdens are thus also reduced.

Another primary benefit of financing method 1001 to retailers 1006 is that the retailer 1006 may negotiate and retain control over the transaction with supplier 1005 as it occurs through web site 1050, e.g., the retailer's purchase of clothing from a supplier as the transaction proceeds through coordinator 1002. To this end, retailer 1006 may set the terms and conditions of the transaction, and thus need not use the coordinator 1002 as a typical middleman. This avoids typical middleman fees which may be significant. Instead, retailer 1006 may negotiate a transaction with a supplier 1005, preferably via web site 1050, and arrives at agreeable terms and conditions. When placing the order with coordinator 1002, retailer 1006 may simply add a mark-up value that had been pre-agreed to when signing up with coordinator 1002.

Another benefit is that there are multiple sellers 1005 and thus multiple sources of goods and services for the retailer/buyer 1006 to choose from in the marketplace provided by coordinator 1002. Furthermore one-off transactions are feasible. These attributes are generally not available to retailer/buyers currently.

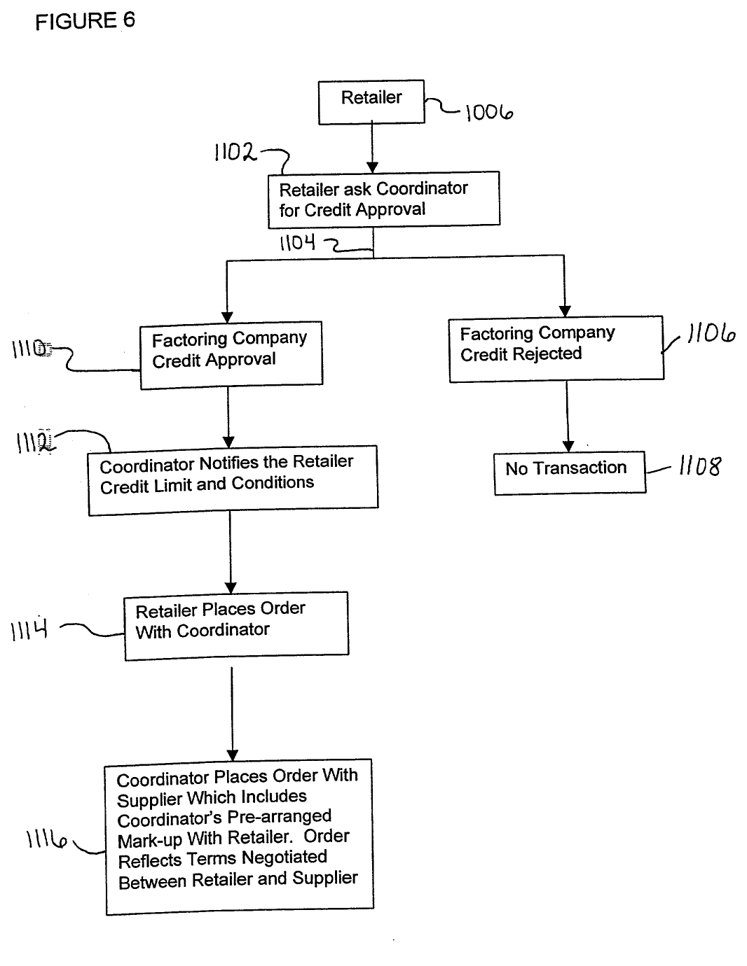

Now that the general relationships between the entities participating in financing method 1001 have been described, reference is now made to FIG. 6 which describes the interaction between coordinator 1002 and retailer 1006 in financing method 1001. As shown in step 1102, retailer 1006 may approach coordinator 1002 seeking credit approval to participate in the financing method 1001. As discussed earlier, retailer 1006 may fill out credit applications and whatever other forms are necessary for this task. These applications and forms may be provided on the coordinator's web site such that retailer 1006 may transmit its credit information electronically, e.g., via e-mail or by filling out forms appearing on the coordinator's web site. Alternatively, other means may be used such as hardcopy credit applications, etc.

As shown in step 1104, coordinator 1002 may then forward the information relevant to retailer's credit application to factor 1004. It is preferred that this occurs electronically. Alternatively, retailer 1006 may send a credit application directly to factor 1004. But in this case, it is preferred that coordinator 1002 be kept apprised of the prospective buyers/retailers 1006 that are applying to participate. It should be noted that this application process may apply to other services provided by coordinator 1002 such as auction 5. In this manner, one application by buyer 1006 may be used to multiple services on the coordinator's web site 1050.

Because the current invention contemplates that the credit information of multiple retailers will be transmitted, it is preferred that appropriate safety mechanisms be used to protect the confidentiality of retailers' financial information. To this end, suitable encryption may be used.

As discussed in connection with audit 5 (FIG. 1), factor 1004 may maintain databases with credit information on various buyers or retailers 1006. If factor 1004 maintains credit information on a prospective buyer 1006, this may streamline the credit check approval step 1102. If not, the coordinator/factor agreement 1010b may provide that factor 1004 receives a fee to perform the credit check, or a higher fee than the one associated with a credit check based on information already in the factor's database.

If the retailer's credit is rejected by factor 1004 as shown in step 1106, there is preferably no transaction involving this particular retailer 1006 as shown in step 1108. It is preferred that non-approved retailers 1006 not participate in the financing method 1001 of the current invention so as to maintain the overall integrity of the lending and factoring relationships between the entities involved. It is also preferred that coordinator 1002 maintain a database of credit rejections that may be considered when a previously rejected buyer 1006 re-applies for credit approval.

If the retailer's credit is approved by factor 1004 as shown in step 1110, factor 1004 may notify coordinator 1002 which may in turn notify retailer 1006 of the approval as shown in step 1112. Alternatively, factor 1004 may notify buyer 1006 directly. Also at this time, factor 1004 or coordinator 1002 may also notify retailer 1006 of any credit limits, or other terms or other conditions that may affect the retailer 1006 as it transacts business using financing method 1001.

In a preferred embodiment, coordinator 1002 or factor 1004 may provide this notification to retailer 1006 electronically such as by e-mail. However, other means of notification may be used such as mail, fax, etc. It should be noted that the approval process of retailer 1006 may also include inquiry into other areas such as the accuracy of billing and shipping addresses.

Thereafter, and as shown in steps 1114 and 1116, retailer 1006 may place orders with suppliers 1005 through coordinator 1002 according to sales terms that may be set forth in the coordinator/retailer agreement 1012. As noted above, it is preferred that retailer 1006 retain control over the negotiations with suppliers 1005. However, it is also preferred that the arrangement 1012 (FIG. 5) between coordinator 1002 and retailer 1006 provides for a pre-arranged mark-up for coordinator 1002 on transactions negotiated by retailer 1006.

A sample transaction involving financing method 1001 is now described. Any particulars set forth about this sample transaction are not intended to limit the scope of the current invention. After obtaining credit approval to participate, retailer 1006 may negotiate a purchase for a quantity of jeans from an overseas supplier 1005 at a landed and duty paid (“LDP”) unit cost of $9.50. LDP generally means that the jeans have landed in the retailer's country and that the duty has been paid on those jeans. Continuing with this example, retailer 1006 may then issue a purchase order to coordinator 1002 (step 1114) for $10.00/piece LDP, with the $0.50 mark-up representing a pre-arranged 5% mark-up, i.e., 5% of $10, per agreement 1012 between coordinator 1002 and retailer 1006. The current invention is not limited to this 5% markup example.

Coordinator 1002 may then issue a “mirror” purchase order to the supplier 1005 (step 1116) for $9.50/piece LDP, i.e., at the price negotiated between retailer 1006 and seller 1005. By “mirror”, it is generally intended that the purchase order received by seller 1005 reflects the terms negotiated with buyer 1006. Accordingly, if there is a dispute between the buyer and seller, the terms they negotiated are clearly set forth in the mirror purchase order. This purchase order may also reflect the coordinator's markup, but the mark-up would preferably be a delineated item such that the price owed to the seller as negotiated with the buyer is clear.

It is preferred that the mirror purchase order from coordinator 1002 to supplier 1005 be transmitted electronically to avoid delays in the transaction. Alternatively, other means of transmission such as fax, mail or other means may be used.

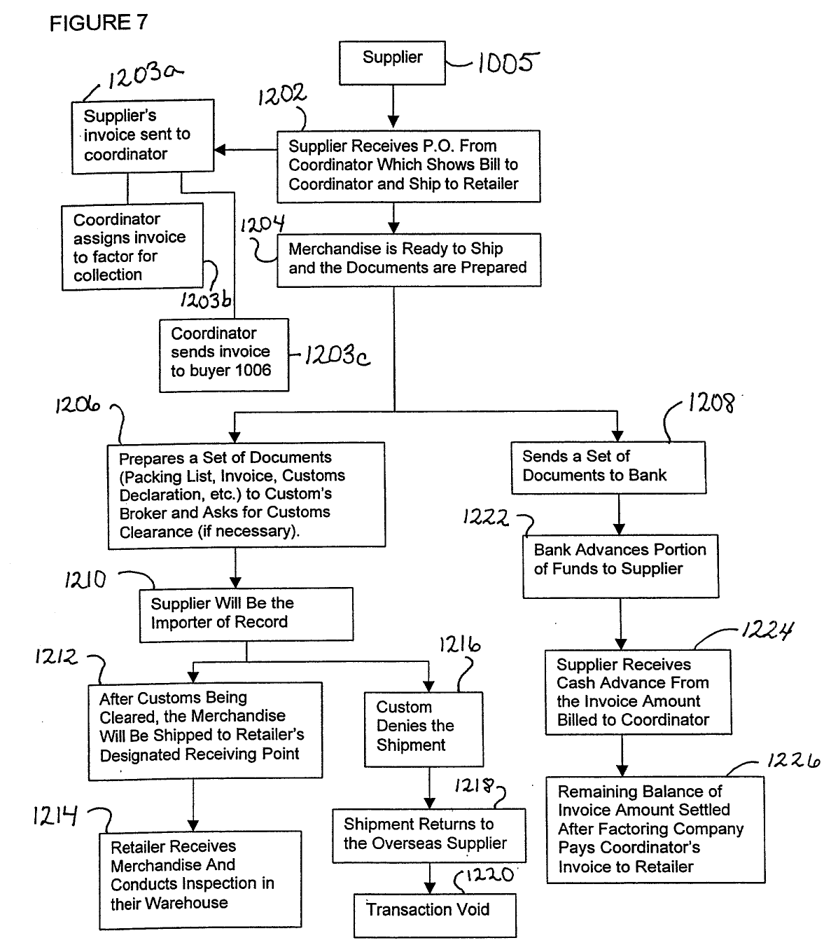

Referring now to FIG. 7 (which generally continues on from where FIG. 6 left off), additional steps in financing method 1001 are discussed in more detail. As shown in step 1202, supplier 1005 may receive the “mirror” purchase order from coordinator 1002. As noted above, the price in this purchase order preferably reflects the price that was negotiated between buyer 1006 and seller 1005, i.e., without the coordinator's mark-up. However, this purchase order may also delineate the coordinator's mark-up. This purchase order preferably provides that the coordinator 1002 should be billed, but that the goods or services ordered should be shipped to retailer 1006. In this manner, the goods will be shipped to the entity ultimately purchasing them, i.e., buyer 1006.

However, the supplier's invoice is sent to coordinator 1002 as shown in step 1203a. In connection with seller 1005 invoicing coordinator 1002, coordinator 1002 takes title to the goods or services and sends a corresponding invoice to buyer 1006 as shown in step 1203c thereby creating an account receivable in the coordinator's favor.

By taking title, coordinator 1002 is thus in a position to assign the invoice and the associated account receivable to factor 1004 per agreement 1010 as in step 1203b. Because invoices will be assigned from coordinator 1002 to factot 1004 in this manner, factor 1004 may perfect its legal position with respect to only one entity, i.e., coordinator 1002. The burdens that would otherwise be associated with perfecting legal positions with respect to multiple entities in possibly multiple foreign countries are thus avoided.

The account receivable assigned from coordinator 1002 to factor 1004 preferably includes the coordinator's mark-up and thus shows the account receivable in favor of the coordinator that was created when the retailer placed the order with the coordinator (step 1114 in FIG. 6). As such, the account receivable assigned to factor 1004 includes the mark-up fee charged by the coordinator to the retailer 1006. Thereafter, factor 1004 may collect the amount due from buyer 1006. The assignment of invoices as in step 1203b allows factor 1004 to be in the position to guarantee payment to bank 1003, which in turn allows bank 1003 to be in the position to advance or loan a portion of the sales price to seller 1005.

As shown in step 1203c, coordinator 1002 sends an invoice to buyer 1006 that generally corresponds to the invoice that coordinator 1002 received from seller 1005. As mentioned above, the coordinator's invoice to buyer 1006 creates the account receivable that is assigned to factor 1004 in step 1203b. As such, it is preferred that steps 1203b,c occur at or around the same time. The invoice from coordinator 1002 to buyer 1006 preferably states that payment should be directly made to factor 1004.

Referring back again to step 1202, upon receiving the purchase order from coordinator 1002, supplier 1005 may also ready the ordered goods or services for shipping and prepare the necessary documents as shown in step 1204. The documents at issue may vary. For example, if supplier 1005 is located overseas, the documents may include packing lists, bills of lading, invoices, documents for customs inspection, e.g., declarations, and duty payments. To this end, it is preferred that coordinator 1002 provide referrals of freight forwarders and advice on customs clearance to facilitate the overall functioning of financing method 1001. To the extent appropriate, it is preferred that documentation associated with payment and shipment be suitable for electronic transmission.

Again where the supplier 1005 is overseas, a set of the appropriate documents are then preferably sent to the appropriate customs office as shown in step 1206. Also, a set of appropriate documents is preferably sent to the appropriate bank 1003 as shown in step 1208. Bank 1003 may be located overseas in situations where the supplier 1005 is located overseas.

The set of documents sent to the appropriate customs office may indicate that supplier 1005 will be the importer of record as shown in step 1210. In this manner, seller 1005 is responsible for customs clearance as in the men's jeans example discussed above. Furthermore, the buyer 1006 avoids the risks associated with being the importer of record as discussed in the background section.

Transactions using financing method 1001 may specify that another entity is the importer of record bearing the obligations associated with customs clearance. To this end, buyer 1006 may negotiate this term with seller 1005 without interference with a middleman. Buyer 1006 may also negotiate with seller 1005 that seller 1005 will be responsible for transporting the ordered goods or services from the port of entry to the retailer's location.

Referring to the left side of FIG. 7, the shipment at this point may be processed by the appropriate customs office. If the shipment clears customs, the shipment will be shipped to the location designated by retailer 1006 as shown in step 1212. At this point, retailer 1006 receives the shipment and may conduct an inspection as shown in step 1214. Financing method 1001 contemplates providing buyer with some amount of time to inspect the shipment before payment is due to ensure that the proper goods were shipped. This protects buyer 1006 from the scam discussed above in connection with LCs, i.e., the buyer has to pay the bank which in turn had to pay the seller merely on the seller presenting shipping documents to the bank—even though the seller may have actually shipped the improper goods or no goods at all.

Alternatively, if the customs office denies the shipment as shown in step 1216, the shipment is returned to supplier 1005 as shown in step 1218, and the transaction is void as shown in step 1220. At this point, the returned shipment would be the seller's issue to deal with since it was the importer of record. Again, the scam associated with fraudulent shipments involving LCs is avoided. Furthermore, the buyer 1006 avoids the risks associated with being listed as the importer of record as discussed in the background section.

Referring now to the right side of FIG. 7, supplier 1005 preferably sends a set of shipping documents to the appropriate bank 1003 as in step 1208. Supplier 1005 may also request an advance or loan at this time (or some other time). Upon receiving these documents, bank 1003 preferably advances or loans a portion of the price associated with the shipment to supplier 1005 as shown in step 1222. The advance or loan may be provided per a buyer/bank agreement.

The amount of advance or loan provided from bank 1003 to supplier 1005 may vary according to an agreement between these two entities. For example, the bank/supplier agreement may provide that bank 1003 advances or loans up to 80% of the amount invoiced from seller 1005 to coordinator 1002. Preferably, this amount would not include the amount of the coordinator's mark-up. Other percentages may be advanced. The percentage of the advance or loan may vary depending on the supplier requesting the advance.

For example, the supplier's record of shipping proper merchandise or other factors may influence the size of the advance or loan available. To this end, any disputes regarding the quality of merchandise shipped by supplier 1005 will generally not be discovered and resolved until after retailer 1006 inspects the merchandise (step 1214), which in turn may generally occur after the advance or loan is provided to supplier 1005 (step 1222).

Because a dispute regarding the merchandise may result in a lower price actually being paid to supplier 1005, the amount held back by bank 1003, e.g., 20% in the case of an 80% advance or loan, may serve as a cushion. With such a cushion, bank 1003 preferably avoids the situation where the advance or loan is larger than the reduced amount to be actually paid to supplier 1005. Accordingly, bank 1003 preferably has the discretion to set the advance or loan amount after performing whatever due diligence investigation into the supplier's track record. And because it is contemplated that bank 1003 will be located in the same country as seller 1005, it is contemplated that any such investigation is not overly burdensome.

The bank/supplier agreement may also specify other terms regarding their relationship. To this end, this agreement may include collection terms that would apply to the advance or loan should it come to pass that supplier 1005 needs to repay bank 1003, e.g., where buyer 1006 received no shipment or an inferior shipment. The bank/supplier agreement may also specify the fees that bank 1003 will charge for any services provided to seller 1005, as well as any interest charges that may arise.

With the financing method 1001 of the current invention, bank 1003 is generally in a position to provide advances or loans due to the security provided by the tri-party agreement 1010 between coordinator 1002, bank 1003 and factor 1004 (FIG. 5). More specifically, bank 1003 advances or loans the funds based on the coordinator's 1002 purchase order to supplier 1005 (and the corresponding invoice from supplier 1003 back to coordinator 1002) and the guarantee of payment by factor 1004.

In other words, bank 1003 is provided with a purchase order and invoice indicating that an order for particular goods or services has been made, as well as with a guarantee that payment for the ordered goods or services will be made. However, the advance or loan is preferably given after bank 1003 receives documentation indicating that supplier 1005 has made the shipment as in step 1208. But again, it should be noted that seller 1005 is preferably required to return the advance or loan to bank 1003 if the shipment does not clear customs as in step 1216. This may be required by the bank/supplier agreement.

As shown in step 1224, supplier 1005 receives the advance or loan from bank 1003 based on the invoice amount billed to coordinator 1002. As discussed above, the percentage of the advance or loan may be at the bank's discretion. The percentage of the advance or loan may generally be based on the purchase price exclusive of the coordinator's mark-up. As shown in step 1226, the remaining balance of the invoice amount billed from supplier 1005 to coordinator 1002 may be settled after factor 1004 pays coordinator's 1002 invoice to retailer 1006.

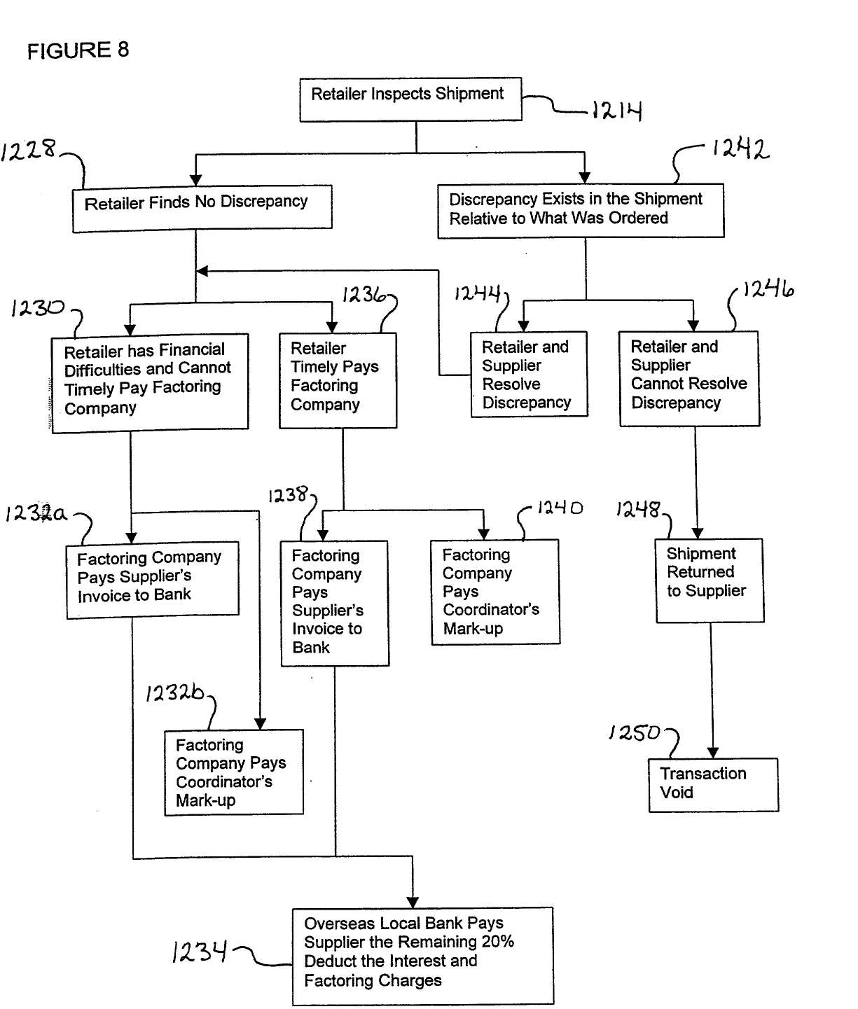

Referring now to FIG. 8, additional steps in the financing method 1001 of the current invention pertaining to retailer 1006 are now described. FIG. 8 generally continues on in financing method 1001 from where step 1214 (retailer inspection of the goods or services) in FIG. 7 left off.

Upon inspection, one possibility is that retailer 1006 finds no discrepancy in the shipment relative to what was ordered as shown in step 1228. Where there is no discrepancy, retailer 1006 should generally provide payment for the shipment. However, as shown in step 1230, the financing method 1001 of the current invention provides for the contingency that retailer 1006 does not timely pay factor 1004, e.g., where retailer 1006 has financial difficulties.

In this situation, buyer 1006 may be required to pay interest to factor 1004 on past due amounts. However, factor 1004 still pays bank 1003 pursuant to the tri-party agreement 1010 as shown in step 1232a. Indeed, it is this guarantee of payment that provides security so as to put bank 1003 in the position to advance or loan funds to supplier 1005. As shown in step 1232b, factor 1004 pays the coordinator's 1002 markup.

Though the exact terms of tri-party agreement 1010 may vary, one example of the factor's obligation to pay bank 1003 (as well as the coordinator's markup fee to coordinator 1002) may arise if buyer 1006 does not pay within 90 days of the payment due date. Factor 1004 may also pay bank 1003 upon the instruction of coordinator 1002.

The payment to bank 1003 by factor 1004 is preferably based on the amount of the supplier's invoice to coordinator 1002. Factor 1004 may retain a portion of this amount to reflect its fees for factoring services. To this end, the factor's fees may be expressed as a percentage of the account receivable assigned to it, e.g., 1.5% of $10 in the men's jeans example discussed above. Factor 1004 may also retain a portion to reflect wire fees, charge backs, handling charges, etc. Factor 1004 may also then initiate collection proceedings against buyer 1006.

After bank 1003 receives payment from factor 1004, and as shown in step 1234, bank 1003 then preferably pays supplier 1005 the remaining percentage of the amount of the supplier invoice billed to coordinator 1002, i.e., the total invoice less the funds already advanced or loaned. Bank 1003 may also deduct appropriate interest, or other charges. As discussed above, such interest, and/or other charges may be set forth in the bank/supplier agreement. These fees may be considered justified in view of the advances or loans provided by bank 1003. So in the case where bank 1003 had previously advanced or loaned 80% of the supplier's invoice to coordinator 1002, bank 1003 pays the remaining 20% less interest and other charges. As mentioned above, different percentages of the supplier's invoice may be advanced or loaned and paid as a remainder.

Referring back up to step 1228 where retailer 1006 finds no discrepancy in the shipment, another scenario is shown by FIG. 8 whereby retailer 1006 timely pays factor 1004 as shown in step 1236. Thereafter, factor 1004 may retain its fees for factoring and other services and then pay bank 1003 for the supplier's invoice to coordinator 1002 (step 1238) as well as the mark-up due coordinator 1002 (step 1240). Bank 1003 may then pay supplier 1005 the remaining portion of the supplier invoice less interest and charges as shown in step 1234.

Referring now to near the top of FIG. 8, another scenario is described as shown in step 1242 wherein the inspection of the shipment by retailer 1006 reveals some type of discrepancy in relation to what was ordered from supplier 1005. There are various discrepancies that may exist, including but not limited to, incorrect quantity, incorrect merchandise, etc. Accordingly, the current invention is not limited to situations where a certain type of discrepancy may be found.

After the discrepancy is found, the financing method 1001 contemplates the scenario whereby retailer 1006 and supplier 1005 resolve the discrepancy as shown in step 1244. For example, the web site of coordinator 1002 may provide sub pages whereby retailer 1006 and supplier 1005 may communicate to resolve the discrepancy. Alternatively, other means of communication may be used such as e-mail, phone, etc. To this end, the resolution of the discrepancy may involve a downward adjustment of the amount owed on the supplier's invoice.

Where there is a downward adjustment, coordinator 1002 and factor 1004 may, in one embodiment, receive less payment for their fees if their fees were expressed as percentages of the account receivable. In an alternative embodiment, these fees may remain the same if expressed as fixed fees. The fees due to bank 1003, e.g., factoring fees, may also vary according to any such adjustment.

It should also be noted that if the payment due to supplier 1005 is adjusted downwardly enough, supplier may need to return some of the advance (or repay early on the loan) provided by bank 1003. But as mentioned above, bank 1003 preferably avoids this situation by investigating the supplier's shipping record and providing appropriate advances. In any event, the bank/supplier agreement may provide for the return of advances (or early repayment of the loan) in such situations.

If the discrepancy is resolved, the financing method 1001 of the current invention may then proceed as described earlier in connection with FIG. 8, i.e., payment by retailer as shown in step 1236. If the discrepancy is resolved and retailer 1006 then has difficulty in making payment, the financing method 1001 of the current invention may proceed as shown in steps 1230, 1232 and 1234 whereby factor 1004 retains its fees and pays bank 1003 and coordinator 1002, and bank 1003 pays supplier 1005 the balance remaining on the invoice.

If retailer 1006 and supplier 1005 cannot resolve the discrepancy as shown in step 1246, the shipment may be returned to supplier 1005 as shown in step 1248 and the transaction is not completed as shown in step 1250. In this situation, supplier 1005 preferably returns any advance (or repays the loan) to bank 1003 that may have been provided by this time. Supplier 1005 may also be charged transaction costs incurred by bank 1003, factor 1005 and coordinator 1002, and/or penalties. Such costs and penalties may be specified in the coordinator/supplier agreement 1011 prior to seller 1005 transacting business using financing method 1001.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A system for providing a sales transaction of goods or services between a buyer and a seller, the system comprising:
a coordinator
that receives a first purchase order from the buyer,
that issues a second purchase order to the seller based on the first purchase order,
that receives an invoice from the seller based on the second purchase order, and
that assumes title in the invoice;
a financial institution
that receives an interest in the invoice from the coordinator, and
that guarantees the buyer's payment; and
a bank that advances or loans at least a portion of the invoice to the seller based on the guarantee from the financial institution.

2. The system of claim 1 wherein the first purchase order includes a mark-up representing the coordinator's fee for providing the sales transaction.

3. The system of claim 2 wherein the mark-up is agreed upon between the coordinator and the buyer prior to the transaction.

4. The system of claim 1 wherein the coordinator issues a coordinator's invoice to the buyer indicating that the buyer is to pay the financial institution.

5. The system of claim 1 wherein the financial institution is located in the same country as the coordinator, and the bank is located in the same country as the seller.

6. The system of claim 1 wherein the financial institution investigates the buyer's credit and notifies the coordinator of whether the buyer's credit is approved to participate in the system and of any limitations on the buyer's credit.

7. The system of claim 1 wherein the coordinator assigns the invoice to the financial institution.

8. The system of claim 7 wherein the financial institution perfects its legal position in the assigned invoice with respect to the coordinator.

9. The system of claim 1 wherein the second purchase order indicates that the coordinator is to be billed for the transaction and that the goods or services are to be shipped to the buyer.

10. The system of claim 1, further comprising a set of shipping documents prepared by the seller that indicate the seller to be the importer of record, that are presented to the custom's office of the buyer's country, and that are presented to the bank.

11. The system of claim 10 wherein the bank provides the advance or loan to the seller upon receipt of the shipping documents, the advance or loan being a percentage of the invoice from the seller to the coordinator.

12. The system of claim 11 wherein the percentage is agreed upon between the bank and the seller prior to the transaction.

13. The system of claim 1, further comprising a time period during which the buyer inspects the goods or services received from the seller.

14. The system of claim 13 wherein the buyer finds no discrepancy between the goods or services ordered and the goods or services actually received.

15. The system of claim 14 wherein the buyer pays the financial institution, the financial institution pays the mark-up to the coordinator, the financial institution pays the bank less any applicable charges of the financial institution, and the bank pays the seller less the amount of the advance or loan and any applicable charges of the bank.

16. The system of claim 13 wherein the buyer finds a discrepancy between the goods or services ordered and the goods or services actually received.

17. The system of claim 16 wherein the buyer and seller negotiate amended terms of the transaction to accommodate the discrepancy.

18. The system of claim 17 wherein the buyer pays a portion of the amount due to the financial institution, the financial institution pays the coordinator a portion of the mark-up, the financial institution pays the bank a portion of the invoice amount less any applicable charges of the financial institution, and the bank pays the seller a reduced amount less the amount or loan of the advance and any applicable charges of the bank.

19. The system of claim 1 wherein the goods or services are not accepted by the buyer and the seller pays back the advance or loan to the bank plus any applicable charges of the bank.

20. The system of claim 1, wherein the first purchase order and second purchase order are transmitted electronically.

21. A method for a coordinator to provide a sales transaction of goods or services between a buyer and a seller, the method comprising:
transmitting a first purchase order from the buyer to the coordinator;
transmitting a second purchase order from the coordinator to the seller based on the first purchase order;
transmitting an invoice from the seller to the coordinator based on the second purchase order, wherein the coordinator assumes title in the invoice;
assigning an interest in the invoice by the coordinator to a financial institution;
guaranteeing payment of the invoice by the financial institution to a bank; and
advancing or loaning at least a portion of the invoice by the bank to the seller based on the guarantee from the financial institution.

22. The method of claim 21, further comprising including a mark-up in the first purchase order representing the coordinator's fee for providing the sales transaction.

23. The method of claim 22 wherein the mark-up is agreed upon between the coordinator and the buyer prior to the transaction.

24. The method of claim 21 wherein the coordinator issues a coordinator's invoice to the buyer indicating that the buyer is to pay the financial institution.

25. The method of claim 21 wherein the financial institution is located in the same country as the buyer, and the bank is located in the same country as the seller.

26. The method of claim 21, further comprising the financial institution investigating the buyer's credit and notifying the coordinator of whether the buyer's credit is approved to participate in the method and of any limitations on the buyer's credit.

27. The method of claim 21, further comprising the coordinator assigning the invoice to the financial institution.

28. The method of claim 27, further comprising the financial institution perfecting its legal position in the assigned invoice with respect to the coordinator.

29. The method of claim 21 wherein the second purchase order indicates that the coordinator is to be billed for the transaction and that the goods or services are to be shipped to the buyer.

30. The method of claim 21, further comprising
the seller preparing a set of shipping documents that indicate the seller to be the importer of record;
presenting the shipping documents to the custom's office of the buyer's country; and
presenting the shipping documents to the bank.

31. The method of claim 30, further comprising the bank providing the advance or loan to the seller upon receipt of the shipping documents, the advance or loan being a percentage of the invoice from the seller to the coordinator.

32. The method of claim 31 wherein the percentage is agreed upon between the bank and the seller prior to the transaction.

33. The method of claim 21, further comprising providing a time period for the buyer to inspect the goods or services received from the seller.

34. The method of claim 33 wherein the buyer finds no discrepancy between the goods or services ordered and the goods or services actually received.

35. The method of claim 34, further comprising:
the buyer paying the financial institution;
the financial institution paying the mark-up to the coordinator;
the financial institution paying the bank less any applicable charges of the financial institution; and
the bank paying the seller less the amount of the advance or loan and any applicable charges of the bank.

36. The method of claim 33 wherein the buyer finds a discrepancy between the goods or services ordered and the goods or services actually received.

37. The method of claim 36 wherein the buyer and seller negotiate amended terms of the transaction to accommodate the discrepancy.

38. The method of claim 37, further comprising:
the buyer paying a portion of the amount due to the financial institution;
the financial institution paying the coordinator a portion of the markup;
the financial institution paying the bank a reduced amount less any applicable charges of the financial institution; and
the bank paying the seller a reduced amount less the amount of the advance or loan and any applicable charges of the bank.

39. The method of claim 21 wherein the goods or services are not accepted by the buyer and the seller pays back the advance or loan to the bank plus any applicable charges of the bank.

40. The method of claim 21, wherein the first purchase order and second purchase order are transmitted electronically.
